(19) United States
(12) Patent Application Publication
(10) Pub. No.: US 2013/0268290 A1
(43) Pub. Date: Oct. 10, 2013

(54) SYSTEMS AND METHODS FOR DISEASE KNOWLEDGE MODELING

(71) Applicants: DAVID JACKSON, Heidelberg (DE); Stephan Brock, Weinheim (DE); Alexander Zien, Karlsruhe (DE)

(72) Inventors: DAVID JACKSON, Heidelberg (DE); Stephan Brock, Weinheim (DE); Alexander Zien, Karlsruhe (DE)

(21) Appl. No.: 13/828,862

(22) Filed: Mar. 14, 2013

Related U.S. Application Data
(60) Provisional application No. 61/619,255, filed on Apr. 2, 2012.
(60) Provisional application No. 61/757,805, filed on Jan. 29, 2013.

(51) Int. Cl. G06F 19/00

(52) U.S. Cl. CPC G06F 19/345
USPC 705/2

(57) ABSTRACT

Systems and methods are described herein for disease knowledge modeling and clinical treatment decision support, and the prioritization of possible treatment options based on tumor or other disease biomarkers. Disease or indication information, including identification of biomolecular entities associated with the indication may be culled through text data mining to create a knowledge model of the indication. In some embodiments, the knowledge model may comprise a network of associations between molecular entities, including such drug targets and biomakers, genes, pathways. The model may be combined with patient-specific variant information and historical treatment records to identify and prioritize treatment decisions and allow for the prediction of disease drivers and provide treatment options tailored to a patient's genetic data.

### RELATED APPLICATIONS

The present application claims priority to and the benefit of U.S. Provisional Patent Application No. 61/619,255, entitled “Systems and Methods for Disease Knowledge Modeling,” filed Apr. 2, 2012; and U.S. Provisional Patent Application No. 61/757,805, entitled “Systems and Methods for Clinical Decision Support,” filed Jan. 29, 2013; the entirety of each of which are hereby incorporated by reference.

### FIELD OF THE DISCLOSURE

The present disclosure relates to systems and methods for bioinformatics and data processing. In particular, the present disclosure relates to methods and systems for disease knowledge modeling and prioritizing possible treatment options based on mined biomedical data and associated disease models.

### BACKGROUND OF THE DISCLOSURE

A large number of publications exist regarding human disease etiology and progression, discussing various molecular entities such as proteins, small molecules such as metabolites, nutrients, drugs, transporters, enzymes, pathways, and other information. Additionally, with revolutionary advances occur in profiling technologies, the amount of new literature is constantly increasing. With such a large mass of data, it may be difficult for researchers to easily and quickly perform analyses, and is difficult for clinicians to identify personalized patient treatment options.

### BRIEF SUMMARY OF THE DISCLOSURE

In one aspect, the present disclosure is directed to systems and methods for disease knowledge modeling and clinical treatment decision support. Disease or indication information, including identification of biomolecular entities associated with the indication, such as protein targets, pathways, enzymes, drugs, transporters, or other entities may be culled through text data mining from journals, abstracts, clinical trials, medication information, genome information, gene expression, diagnostic materials, research reports, regulatory information, histology or pathology reports, or any other available sources, to create a knowledge model of the indication. In some embodiments, the knowledge model may comprise a network of associations between molecular entities, including such drug targets and biomarkers, genes, pathways. The model may be combined with patient-specific variant information and historical treatment records to identify and prioritize treatment decisions.

In one aspect, the present disclosure is directed to method for prioritizing treatment decisions. The method includes retrieving, by an analyzer executed by a processor of a computing device, an identification of a patient indication. The method also includes identifying, by the analyzer, a plurality of proteins or genes associated with the patient indication, and at least one genetic variant associated with the patient indication. The method further includes selecting, by the analyzer, a subset of the plurality of proteins or genes responsive to an identified functional impact of the genetic variant on the protein or gene associated with the patient identification. The method also includes generating, by the analyzer, an indication-specific molecular entity network based on the selected subset of the plurality of proteins or genes. The method also includes retrieving, by the analyzer from a medication information database, an identification of a plurality of medications having one or more targets in the indication-specific molecular entity network. The method includes generating, by the analyzer, a prioritized list of suggested treatments, each comprising one or more of the plurality of medications, wherein the priority of a suggested treatment depends on a number of targets, in particular unique targets, in the indication-specific molecular entity network affected by the one or more medications of the suggested treatment.

In one embodiment of the method, identifying a plurality of proteins or genes associated with the patient indication comprises searching a literature database for identifications of a protein or gene having a co-occurrence frequency with identifications of the patient indication greater than a first threshold. In another embodiment of the method, identifying at least one genetic variant associated with the patient indication comprises searching a literature database for identifications of a genetic variant having a co-occurrence frequency with identifications of the patient indication greater than a second threshold.

In some embodiments of the method, selecting a subset of the plurality of proteins or genes further comprises identifying activation or repression of a gene or amplification or deletion of a protein by the genetic variant, and selecting said protein or gene for inclusion in the indication-specific molecular entity network responsive to the identification. In other embodiments of the method, identifying activation or repression of a gene or amplification or deletion of a protein by the genetic variant comprises searching a literature database for identifications of the protein or gene having a co-occurrence frequency with identifications of the genetic variant and identifications of activation, repression, amplification, or deletion. In still other embodiments of the method, generating an indication-specific molecular entity network comprises extracting a subgraph from a global molecular entity graph, the subgraph comprising the selected subset of the plurality of proteins or genes.

In one embodiment of the method, the priority of a suggested treatment is further based on a stage of development of a medication of the suggested treatment. In another embodiment of the method, the priority of a suggested treatment is proportional to the number of targets in the indication-specific molecular entity network affected by the one or more medications of the suggested treatment. In still another embodiment of the method, the priority of a suggested treatment is dependent on a number of medications of the suggested treatment. In a further embodiment of the method, the priority of a suggested treatment is inversely proportional to the number of medications of the suggested treatment.

In another aspect, the present disclosure is directed to a system for prioritizing treatment decisions. The system includes a computing device comprising a processor and a memory. The processor executes an analyzer configured for retrieving an identification of a patient indication. The analyzer is further configured for identifying a plurality of proteins or genes associated with the patient indication, and at least one genetic variant associated with the patient indication. The analyzer is also configured for selecting a subset of the plurality of proteins or genes responsive to an identified functional impact of the genetic variant on the protein or gene associated with the patient identification. The analyzer is also configured for generating an indication-specific molecular entity network based on the selected subset of the plurality of proteins or genes. The analyzer is also configured for retrieving, from a medication information database, an identification of a plurality of medications having one or more targets in the indication-specific molecular entity network. The analyzer is further configured for generating a prioritized list of suggested treatments, each comprising one or more of the plurality of medications, wherein the priority of a suggested treatment is dependent on, in particular proportional to a number of targets, in particular unique targets, in the indication-specific molecular entity network affected by the one or more medications of the suggested treatment.

In one embodiment, the analyzer is further configured for searching a literature database for identifications of a protein or gene having a co-occurrence frequency with identifications of the patient indication greater than a first threshold. In another embodiment, the analyzer is further configured for searching a literature database for identifications of a genetic variant having a co-occurrence frequency with identifications of the patient indication greater than a second threshold. In still another embodiment, the analyzer is further configured for identifying activation or repression of a gene or amplification or deletion of a protein by the genetic variant, and selecting said protein or gene for inclusion in the indication-specific molecular entity network responsive to the identification. In a further embodiment, the analyzer is further configured for searching a literature database for identifications of the protein or gene having a co-occurrence frequency with identifications of the genetic variant and identifications of activation, repression, amplification, or deletion. In some embodiments, the analyzer is further configured for extracting a subgraph from a global molecular entity graph, the subgraph comprising the selected subset of the plurality of proteins or genes.

In some embodiments of the system, the priority of a suggested treatment is further based on a stage of development of a medication of the suggested treatment. In other embodiments of the system, the priority of a suggested treatment is dependent on, in particular inversely proportional to the number of medications of the suggested treatment.

In another aspect, the present disclosure is directed to systems and methods for the prioritization of possible treatment options based on tumor and germline-based biomarkers. The system and methods may allow for the prediction of disease drivers and provide treatment options tailored to a patient's genetic data. Furthermore, the system and method provides a means for prioritizing the possible treatment options based on the extraction and contextualization of clinical and molecular knowledge of a specific disease. The system gathers biomarker information and transforms the information into prioritized, clinically actionable options identified for a specific patient case.

In one embodiment, the present disclosure is directed to a method for prioritization of patient treatment options based on multivariate analysis of biomarker information. The method includes retrieving, by an analysis engine executed by a computing device, an identification of an indication of a patient and the results of measurements of a set of one or more biomarkers in the patient. The method further includes identifying, by the analysis engine, a plurality of treatments associated with the indication, the patient, or any of the set of one or more biomarkers in a treatment information database. The method also includes generating, by the analysis engine, a score for each of the identified plurality of treatments, the score being based on a) clinical validation levels of predictive rules for each of the one or more biomarkers; b) whether predictive rules for each of the one or more biomarkers are associated with response to the treatment, resistance to the treatment, or risk of adverse effects from the treatment; and c) a reliability of measurement of each of the one or more biomarkers. The method also includes ordering at least a portion of the identified plurality of treatments according to the generated score to provide a treatment option or treatment contraindication prioritization for the patient.

In some embodiments of the method, generating a score for each of the identified plurality of treatments further comprises, for each generated score: generating a plurality of sub-scores for a corresponding plurality of the set of biomarkers; and aggregating the plurality of sub-scores to generate the score. In further embodiments, aggregating the plurality of sub-scores comprises adding each sub-score for each biomarker associated with the treatment.

In some embodiments, the method includes two or more separate scores are computed for each treatment, said separate scores corresponding to responsiveness, resistance, or risk. Ordering at least a portion of the identified plurality of treatments includes weighting the two or more separate scores according to treatment risk/benefit profile, and aggregating the weighted two or more separate scores to determine the order of treatments. In further embodiments, the treatments are prioritized according to a weighted sum of their separate scores. In a still further embodiment, the method includes specifying, by a user, weights via a treatment/risk benefit profile.

In some embodiments of the method, the clinical validation level is one out of the following list: endorsed, clinical, pre-clinical, inferred. In a further embodiment, a value for the endorsed validation level is set equal to 1; a value for the clinical validation level is set equal to a defined number less than 1, preferably between 0.5 and 1, most preferably equal to 0.8; a value for the pre-clinical validation level is set equal to a defined number less than or equal to 0.2; and a value for the inferred validation level is set equal to a defined number less than or equal to 0.5.

In some embodiments of the method, the value for a predictive rule for the biomarker being associated with response to the medication is set equal to 1; being associated with resistance to the medication is set equal to −1; and being associated with a risk of adverse effects from the medication is set equal to a defined negative value between 0 and −1, in particular equal to −0.2, −0.4, −0.6, or −0.8.

In many embodiments of the method, the value for the reliability of detection of the biomarker comprises a value for a reliability of the detection method of the biomarker and a value for a frequency of detection of the biomarker in the patient. In a further embodiment, the value for the reliability of the detection method of the biomarker and the value for the frequency of detection of the biomarker in the patient are multiplied or averaged in order to build the value for the reliability of detection of the biomarker. In some embodiments of the method, the sub-score is built by a product of values, preferably between 0 and 1, attributed to each feature out of a), b) and c).

In some embodiments, the value for whether a predictive rule for the biomarker is associated with response to the treatment, resistance to the treatment, or risk of adverse effects from the treatment is further based on a measure of an effect size of the predictive rule for the biomarker. In many embodiments of the method, the score is further based on d) a real-valued quantification of the effect size of the predictive rule for each of the one or more biomarkers. In a further embodiment, the effect size of the predictive rule for each of the one or more biomarkers comprises a measurement of a likelihood of response or resistance or a measurement of a hazard ratio. In a still further embodiment, the effect size of each of the predictive rule for the one or more biomarkers comprises a log likelihood of response or resistance ratio or a log hazard ratio. In a yet still further embodiment, the score, in particular the sub-score comprises the real-valued quantification of the effect size multiplied by a function of values attributed to each feature out of a)-c) for each of the one or more biomarkers.

In some embodiments of the method, the score is further based on (e) whether the predictive rule for each of the one or more biomarkers has been validated in an indication of the patient, in a related indication, or in any unrelated indication. In a further embodiment, the value for the predictive rule for the biomarker being validated in an indication of the patient is set equal to 1; and wherein the value for the biomarker being validated in a related indication is set equal to a defined positive value between 0 and 1, in particular equal to 0.2, 0.4, 0.6, or 0.8; and wherein the value for the predictive rule for the biomarker being validated in an unrelated indication is set equal to a defined non-negative value less than the value of a related indication, in particular 0, 0.01, 0.02, 0.05, or 0.1. In a further embodiment, the value for the predictive rule for the biomarker being detected in a related indication is weighted responsive to a homology between involved proteins and/or a structural similarity of exchanged amino acids. In a still further embodiment, the sub-score comprises a product of values, preferably between 0 and 1, attributed to each feature out of a), b), c) and d); or out of a), b), c), and e); or out of a), b), c), d), and e).

In many embodiments of the method, the score is further based on f) an availability of the associated treatment. In a further embodiment, the value for the availability of the associated treatment comprises a defined value between 0 and 1, wherein a higher value corresponds to a greater availability of the associated treatment. In a still further embodiment, the sub-score comprises a product of values, preferably between 0 and 1, attributed to each feature out of a), b), c) and f); or out of a), b), c), d) and f); or out of a), b), c), e), and f); or out of a), b), c), d), e), and f).

In some embodiments, the method includes retrieving an identification of a past treatment history of the patient for the indication. The score is further based on g) the past treatment history of the patient. In a further embodiment, the sub-score comprises a product of values, preferably between 0 and 1, attributed to each feature out of a), b), c) and g); or out of a), b), c), d) and g); or out of a), b), c), e) and g); or out of a), b), c), f) and g); or out of a), b), c), d), e) and g); or out of a), b), c), d), f) and g); or out of a), b), c), e), f), and g); or out of a), b), c), d), e), f) and g). In a still further embodiment, the method includes placing a first treatment of the identified plurality of treatments in a first order position, responsive to the first treatment being identified in a standard treatment guideline.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIGS. 1B and 1C are block diagrams depicting embodiments of computing devices useful in connection with the methods and systems described herein;

FIGS. 2A-2B are block diagrams depicting additional embodiments of computers useful in connection with the methods and systems described herein;

FIG. 3A is a block diagram of an embodiment of a system for multivariate analysis of adverse event data;

FIG. 3B is a diagram of an example embodiment of a global molecular entity graph;

FIG. 3C is a diagram of an example embodiment of extracted subgraphs;

FIG. 4A is a block diagram of an embodiment of a system for disease knowledge modeling and clinical treatment decision support;

FIG. 4B is a block diagram of an embodiment of a method for analysis of disease information for disease knowledge modeling;

FIG. 4C is a block diagram of an embodiment of a system for building a semantic indication model;

FIG. 5 is a block diagram of an embodiment of a system for utilizing semantic indication models and histopathology reports for differentiation analysis of a disease knowledge model;

FIG. 6 is a flow diagram of an embodiment of a method for prioritizing treatment decisions;

FIG. 7 is a tree diagram of an exemplary disease model and prioritized medication information;

FIG. 8 is a block diagram of a clinical decision support device, according to one implementation;

FIG. 9A is an exemplary embodiment of a graphical user interface for a clinical decision support device, similar to the device of FIG. 8;

FIG. 9B is an exemplary embodiment of icons that may provide a clinical user with information regarding the validity of variants; and

FIG. 10 is a flow diagram depicting an embodiment of a method for selecting and prioritizing possible treatment options for a patient.

### DETAILED DESCRIPTION

Knowledge about the molecular mechanisms involved in human disease etiology and progression can be fundamental to advancing the fields of clinical research and drug development. With advances in biomedical sciences, the nature of such knowledge has gradually shifted from predominantly phenotypic to holistic molecular descriptions of bio-molecular processes and networks, which describe the biochemical interplay between individual bio-molecules, including proteins, genes coding for proteins, small molecules such as metabolites, nutrients or drugs and phenotypic effects at the patient level, such as clinical stages of disease progression, processes at the cellular level, drug response or resistance.

At the molecular level, information about the abundance and assembly of proteins in specific disease indications can assist in the elucidation of detailed and accurate disease models. Advances in speed, cost and precision of genome sequencing renders access to this information possible and also permits the investigation of human disease at the level of the individual patient.

Prior to discussing specifics of methods and systems for disease knowledge modeling and prioritization of patient treatment options, it may be helpful to briefly define a few terms as used herein. These definitions are not intended to limit the use of the terms, but rather may provide additional or alternate definitions for use of the terms within some contexts. Accordingly, context may clarify whether, for example, the term indication refers to a symptom or disease, a flag in a database, or a selection by a user. Additionally, the following list of definitions is not intended to be exhaustive, but rather discuss a few key terms that may be helpful to those of skill in the art.

Adverse event: In pharmacology, an adverse event may refer to any unexpected or dangerous reaction to a drug. An unwanted effect caused by the administration of a drug. The onset of the adverse reaction may be sudden or develop over time. Also interchangeably called: adverse drug event (ADE), adverse drug reaction (ADR), adverse effect or adverse reaction.

Absorption, Distribution, Metabolism, Excretion (ADME): ADME refers to the standard pharmacokinetic mechanism of a drug.

Adverse Event Reporting System (AERS): AERS is a computerized information database designed to support the FDA's post-marketing safety surveillance program for all approved drug and therapeutic biologic products. The FDA uses AERS to monitor for new adverse events and medication errors that might occur with these marketed products.

Bioavailability: Also referred to as availability, this is the amount of a drug that is absorbed into circulation after administration of a specific dosage.

Biomarker: The term “biomarker” may be generally referred to in two different ways. In one definition, biomarkers may be simply any measurable quantities. In an alternate definition used herein, the term “biomarker” may also be used for predictive rules that are based on a biomarker. Such predictive rules may comprise a combination of a measurable quantity (e.g. a biomarker as discussed above in the first definition), a value range, an indication, a treatment option, and/or an effect on the outcome. For example, “response”, “resistance”, and “risk” may be possible qualitative descriptions of the type of effect. Accordingly, via such predictive rules, two otherwise similar cohorts of patients with a given indication may be compared, where the first cohort comprises patients with a biomarker measurement value outside a given range and the second cohort comprises patients with the biomarker measurement value inside the given range. The outcomes achieved by a given treatment in both cohorts may differ, as described by a given effect on the outcome. In some implementations, these predictive rules may be referred to variously as an “actionable biomarker”, a “predictive biomarker”, or a “theranostic biomarker”. A biomarker or measured quantity may apply to more than one predictive rule, for example related to different indications or different drugs. Accordingly, in some instances of the term “biomarker” in this disclosure, the predictive rule may rather be meant than the strict biomarker. However, for the person skilled in the art, this will be clear from the context as well.

Challenge-dechallenge-rechallenge (CDR): This is a medical testing protocol in which a medicine (or drug) is administered (challenge), withdrawn (dechallenge), then re-administered (rechallenge), while being monitored for adverse effects (reactions) at each stage.

Contingency table (or matrix): Also referred to as cross tabulation or cross tab. A contingency table is often used to record and analyze the relation between two or more categorical variables. It displays the (multivariate) frequency distribution of the variables in a matrix format.

Drug interaction: A drug interaction is a situation in which a substance affects the activity of a drug, i.e. the effects are increased or decreased, or they produce a new effect that neither produces on its own. However, interactions may also exist between drugs & foods (drug-food interactions), as well as drugs & herbs (drug-herb interactions). These may occur out of accidental misuse or due to lack of knowledge about the active ingredients involved in the relevant substances or the underlying molecular mechanisms.

Entity Coverage/Co-Entity Coverage: The Entity Coverage is an estimate that refers to the significance with which a first entity (E1) is related with a second entity (E2) in a data set. It is calculated from the number of data entries containing E1 and E2 divided by the overall number of data entries containing E1. The Co-Entity Coverage is calculated from the number of data entries containing E1 and E2 divided by the overall number of data entries containing E2. This method gives thus an indication for the significance of entity relations in subsets of data.

Gamma Poisson Shrinker: Advanced method for Pharmacovigilance Signal Detection. In contrast to simple methods that focus on a specific AE-drug-combination at a time (encoded in 2*2 contingency tables), it can directly use contingency tables that range over all drugs and AEs.

Idiosyncratic response: An abnormal response from a drug that is specific to the person having the response.

Indication (or ‘drug use’): In medicine, an indication is a valid reason to use a certain test, medication, procedure, or surgery. An indication may thus refer to a disease, a symptom, or diagnosis. The opposite of indication is contraindication.

Metabolizing enzyme: A protein that metabolizes a medication; the enzyme may help transforming a pro-drug to its pharmacologically active chemical compound form or it may play a role in its degradation.

Molecular mechanism: The flow of events that take place in the molecular level when a drug is administered. The molecular mechanisms can be highly complex due to the variety of participating components (e.g., drugs, organs, cells, proteins, etc.), systems (e.g., pathways, disease networks, etc.), entity interrelations (e.g., drug-target, drug-metabolizing enzyme, carriers, transporters, overlapping systems and pathways, etc.), and molecular aberrations (e.g., mutations, radiation damage, etc.). Components of the molecular mechanism, such as protein targets, pathways, transporters, drugs, or drug classes may be referred to variously as molecular entities or biomolecular entities.

Side effect: Any unintended effect of a pharmaceutical product occurring at a dose normally used in man, which is related to the pharmacological properties of the drug. A side effect may frequently correspond to an indication. For example, nausea may be a side effect of a first drug, but may be an indication to be treated by a second drug. A negative side effect may also be referred to as an adverse event.

For purposes of reading the description of the various embodiments below, the following descriptions of the sections of the specification and their respective contents may be helpful.

Section A describes a network environment and computing environment which may be useful for practicing embodiments described herein.

Section B describes embodiments of systems and methods for disease knowledge modeling.

Section C describes embodiments of systems and methods for prioritizing clinical treatments with a Clinical Decision Support Device.

### A. Computing and Network Environment

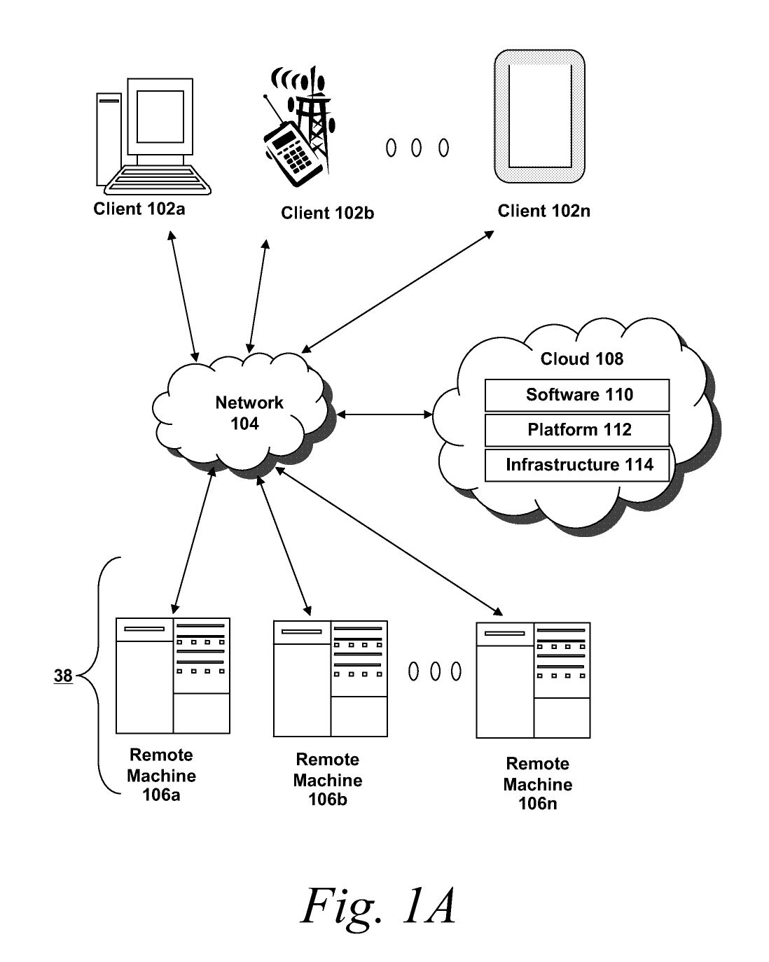

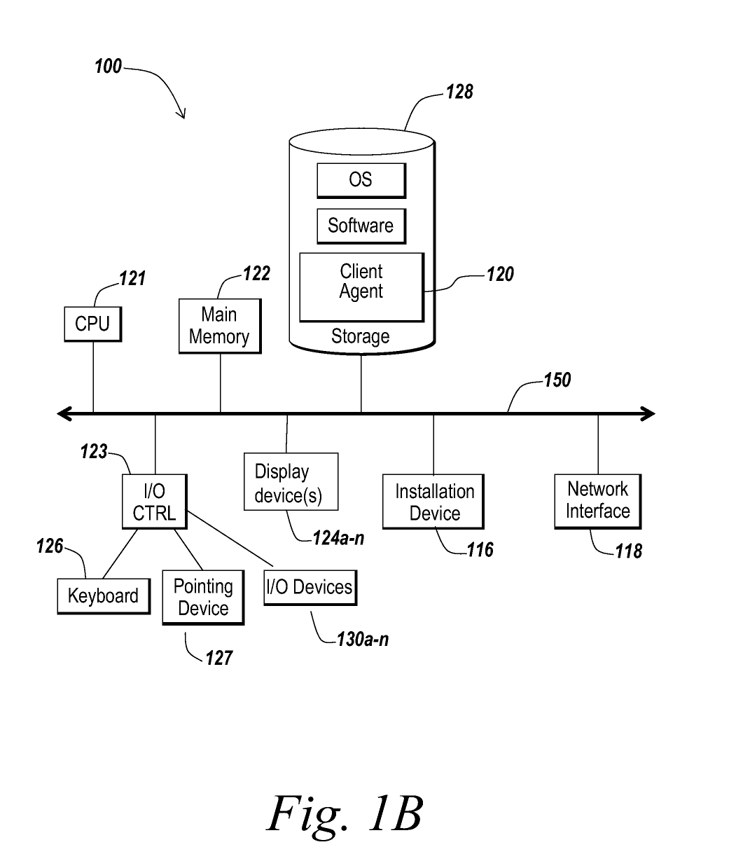

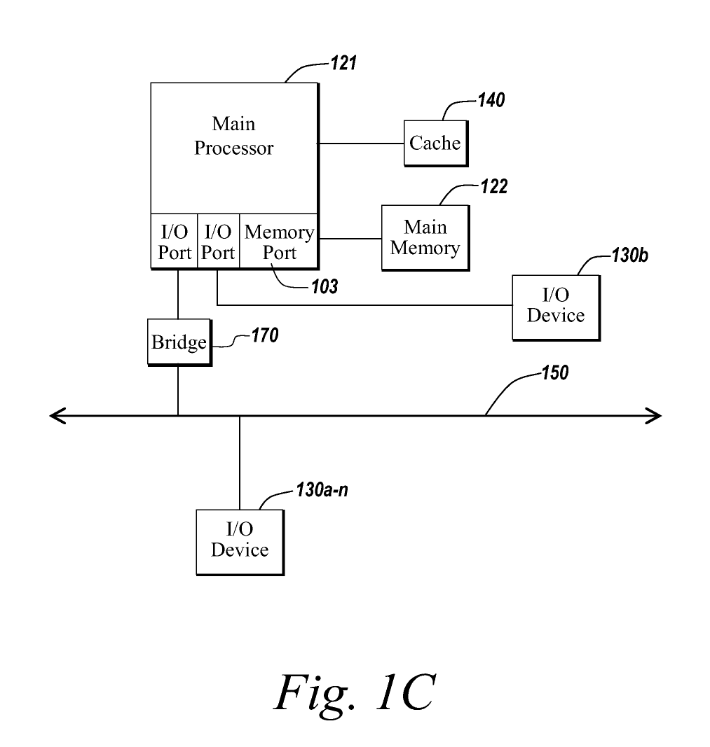

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be connected via wired or wireless links. Wired links may include Digital Subscriber Line (DSL), coaxial cable lines, or optical fiber lines. The wireless links may include BLUETOOTH, Wi-Fi, Worldwide Interoperability for Microwave Access (WiMAX), an infrared channel or satellite band. The wireless links may also include any cellular network standards used to communicate among mobile devices, including standards that qualify as 1G, 2G, 3G, or 4G. The network standards may qualify as one or more generation of mobile telecommunication standards by fulfilling a specification or standards such as the specifications maintained by International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network 104 may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 104 may be a type of a broadcast network, a telecommunications network, a data communication network, or a computer network.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix, Linux, or Mac OS X).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

In some embodiments, A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or a zero client may depend on the connection to the cloud 108 or server 106 to provide functionality. A zero client may depend on the cloud 108 or other networks 104 or servers 106 to retrieve operating system data for the client device. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 108 may include both the private and public networks 104 and servers 106.

The cloud 108 may also include a cloud based delivery, e.g. Software as a Service (SaaS) 110, Platform as a Service (PaaS) 112, and Infrastructure as a Service (IaaS) 114. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif.). Clients 102 may also access SaaS resources through smartphone or tablet applications, including, e.g., Salesforce Sales Cloud, or Google Drive app. Clients 102 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g. a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-124n, a keyboard 126 and a pointing device 127, e.g. a mouse. The storage device 128 may include, without limitation, an operating system, software, and a software of Clinical Decision Support Device 100. As shown in FIG. 1C, each computing device 100 may also include additional optional elements, e.g. a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, Calif.; those manufactured by Motorola Corporation of Schaumburg, Ill.; the ARM processor and TEGRA system on a chip (SoC) manufactured by Nvidia of Santa Clara, Calif.; the POWER7 processor, those manufactured by International Business Machines of White Plains, N.Y.; or those manufactured by Advanced Micro Devices of Sunnyvale, Calif. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of a multi-core processors include the AMD PHENOM IIX2, INTEL CORE i5 and INTEL CORE i7.

Main memory unit 122 may include one or more memory chips capable of storing data and allowing any storage location to be directly accessed by the microprocessor 121. Main memory unit 122 may be volatile and faster than storage 128 memory. Main memory units 122 may be Dynamic random access memory (DRAM) or any variants, including static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphics Port (AGP) to communicate with the display 124 or the I/O controller 123 for the display 124. FIG. 1C depicts an embodiment of a computer 100 in which the main processor 121 communicates directly with I/O device 130b or other processors 121′ via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple IPHONE. Some devices 130a-130n allow gesture recognition inputs through combining some of the inputs and outputs. Some devices 130a-130n provides for facial recognition which may be utilized as an input for different purposes including authentication and other commands. Some devices 130a-130n provides for voice recognition and inputs, including, e.g., Microsoft KINECT, SIRI for IPHONE by Apple, Google Now or Google Voice Search.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augment reality devices. The I/O devices may be controlled by an I/O controller 123 as shown in FIG. 1B. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, an I/O device 130 may be a bridge between the system bus 150 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1B, the computing device 100 may comprise a storage device 128 (e.g. one or more hard disk drives or redundant arrays of independent disks) for storing an operating system or other related software, and for storing application software programs. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as a installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif., among others. Some operating systems, including, e.g., the CHROME OS by Google, may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash. The gaming system may be repurposed, for example to form inexpensive nodes of a grid computer.

In some embodiments, the computing device 100 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Wash. In other embodiments, the computing device 100 is a eBook reader, e.g. the KINDLE family of devices by Amazon.com, or NOOK family of devices by Barnes & Noble, Inc. of New York City, N.Y.

In some embodiments, the communications device 102 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

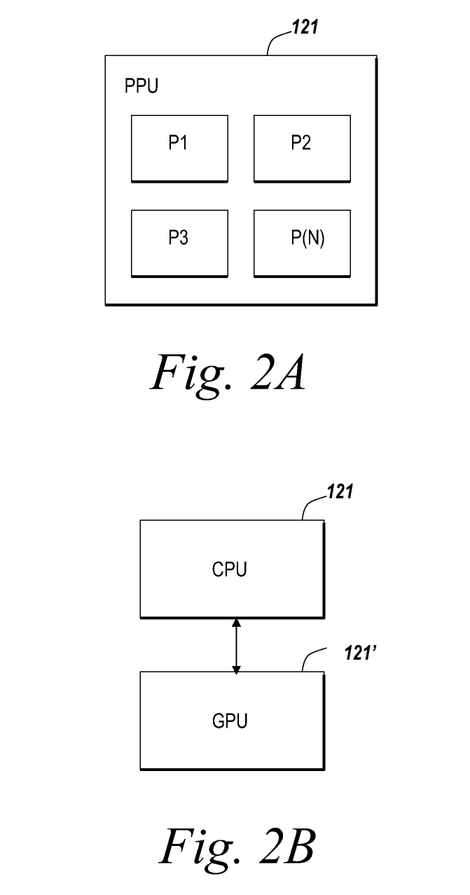

As shown in FIG. 2A, the computing device 100 may comprise multiple processors and may provide functionality for simultaneous execution of instructions or for simultaneous execution of one instruction on more than one piece of data. In some examples, the computing device 100 may comprise a parallel processor with one or more cores. In one of these examples, the computing device 100 is a shared memory parallel device, with multiple processors and/or multiple processor cores, accessing all available memory as a single global address space. In another of these examples, the computing device 100 is a distributed memory parallel device with multiple processors each accessing local memory only. In still another of these examples, the computing device 100 has both some memory which is shared and some memory which can only be accessed by particular processors or subsets of processors. In still even another of these examples, the computing device 100, such as a multicore microprocessor, combines two or more independent processors into a single package, often a single integrated circuit (IC). In yet another of these examples, the computing device 100 includes a chip having a CELL BROADBAND ENGINE architecture and including a Power processor element and a plurality of synergistic processing elements, the Power processor element and the plurality of synergistic processing elements linked together by an internal high speed bus, which may be referred to as an element interconnect bus.

In some examples, the processors provide functionality for execution of a single instruction simultaneously on multiple pieces of data (SIMD). In other examples, the processors provide functionality for execution of multiple instructions simultaneously on multiple pieces of data (MIMD). In still other examples, the processor may use any combination of SIMD and MIMD cores in a single device.

In some examples, the computing device 100 may comprise a graphics processing unit. In one of these examples, depicted in FIG. 2B, the computing device 100 includes at least one central processing unit 121 and at least one graphics processing unit. In another of these examples, the computing device 100 includes at least one parallel processing unit and at least one graphics processing unit. In still another of these examples, the computing device 100 includes a plurality of processing units of any type, one of the plurality of processing units comprising a graphics processing unit.

In one example, a resource may be a program, an application, a document, a file, a plurality of applications, a plurality of files, an executable program file, a desktop environment, a computing environment, or other resource made available to a user of the local computing device 102. The resource may be delivered to the local computing device 102 via a plurality of access methods including, but not limited to, conventional installation directly on the local computing device 102, delivery to the local computing device 102 via a method for application streaming, delivery to the local computing device 102 of output data generated by an execution of the resource on a third computing device 106b and communicated to the local computing device 102 via a presentation layer protocol, delivery to the local computing device 102 of output data generated by an execution of the resource via a virtual machine executing on a remote computing device 106, or execution from a removable storage device connected to the local computing device 102, such as a USB device, or via a virtual machine executing on the local computing device 102 and generating output data. In some examples, the local computing device 102 transmits output data generated by the execution of the resource to another client computing device 102b.

In some examples, a user of a local computing device 102 connects to a remote computing device 106 and views a display on the local computing device 102 of a local version of a remote desktop environment, comprising a plurality of data objects, generated on the remote computing device 106. In one of these examples, at least one resource is provided to the user by the remote computing device 106 (or by a second remote computing device 106b) and displayed in the remote desktop environment. However, there may be resources that the user executes on the local computing device 102, either by choice, or due to a policy or technological requirement. In another of these examples, the user of the local computing device 102 would prefer an integrated desktop environment providing access to all of the resources available to the user, instead of separate desktop environments for resources provided by separate machines. For example, a user may find navigating between multiple graphical displays confusing and difficult to use productively. Or, a user may wish to use the data generated by one application provided by one machine in conjunction with another resource provided by a different machine. In still another of these examples, requests for execution of a resource, windowing moves, application minimize/maximize, resizing windows, and termination of executing resources may be controlled by interacting with a remote desktop environment that integrates the display of the remote resources and of the local resources. In yet another of these examples, an application or other resource accessible via an integrated desktop environment—including those resources executed on the local computing device 102 and those executed on the remote computing device 106—is shown in a single desktop environment.

In one example, data objects from a remote computing device 106 are integrated into a desktop environment generated by the local computing device 102. In another example, the remote computing device 106 maintains the integrated desktop. In still another example, the local computing device 102 maintains the integrated desktop.

In some examples, a single remote desktop environment 204 is displayed. In one of these examples, the remote desktop environment 204 is displayed as a full-screen desktop. In other examples, a plurality of remote desktop environments 204 is displayed. In one of these examples, one or more of the remote desktop environments are displayed in non-full-screen mode on one or more display devices 124. In another of these examples, the remote desktop environments are displayed in full-screen mode on individual display devices. In still another of these examples, one or more of the remote desktop environments are displayed in full-screen mode on one or more display devices 124.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Disease Knowledge Modeling

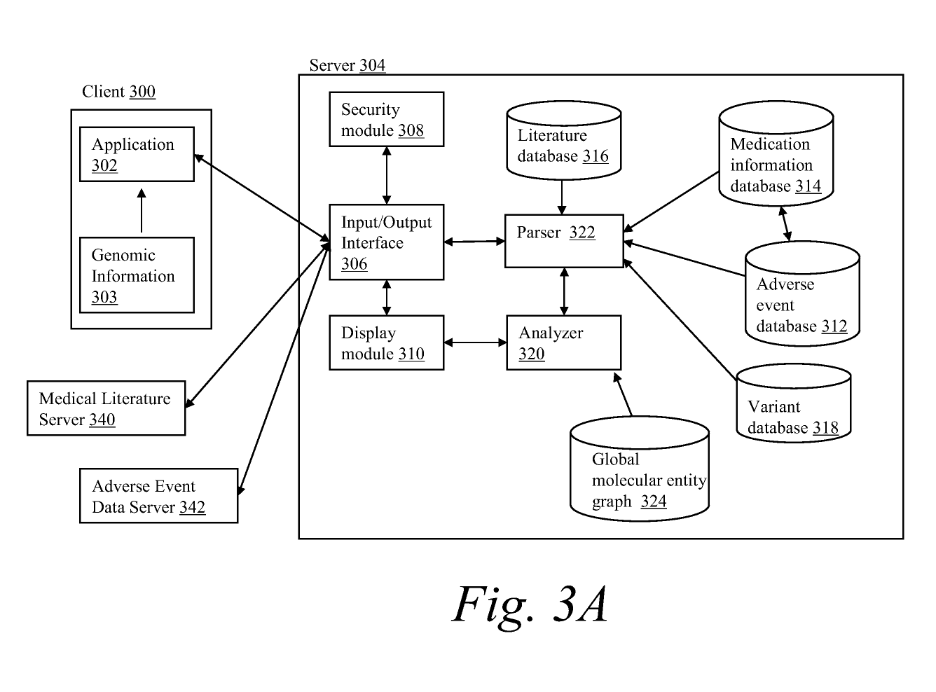

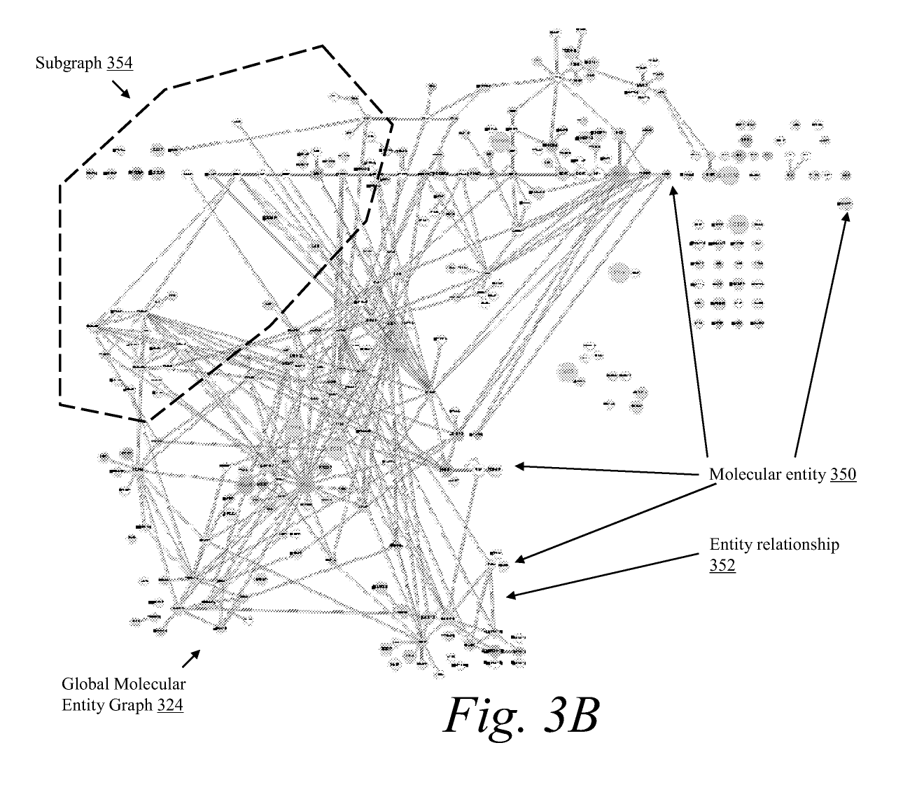

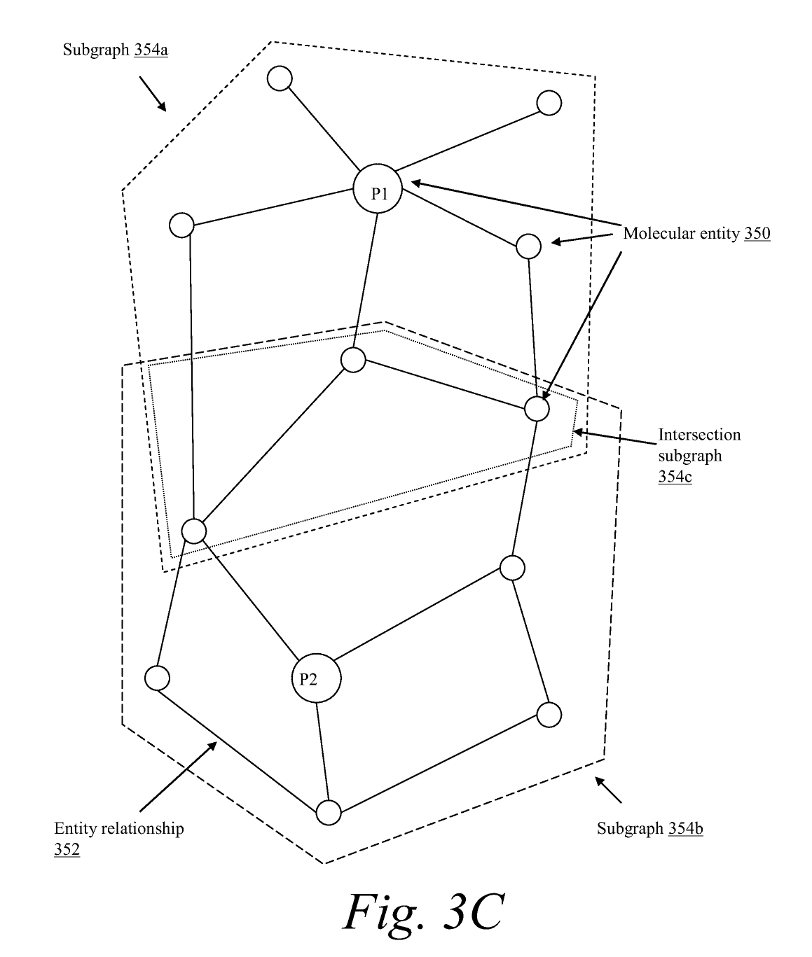

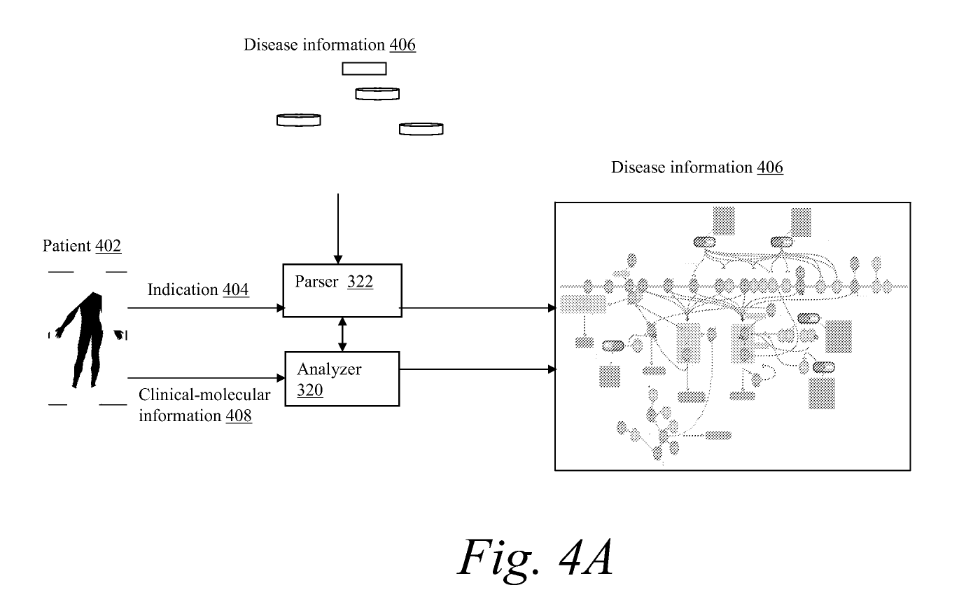

Referring now to FIG. 3A, illustrated is a block diagram of a system for disease knowledge modeling and clinical treatment decision support. In brief overview, a client 300 may comprise an application 302 and, in some embodiments, genetic information or genomic information 303. In some embodiments, a client 300 may communicate with a server 304 via any type of network, such as those discussed herein. Although shown as a separate client-server system, in many embodiments, a client 300 and server 304 may be on the same physical machine. In other embodiments, server 304 may be executed by a virtual machine provided by a cloud computing environment. For example, server 304 may comprise a hosted service or cloud service, providing scalability and ease of management. In some embodiments, a medical literature server 340 and/or an adverse event data server 342 may also communicate with a server 304. In other embodiments not shown, a second client 300 may be used to gather data from a medical literature server 340 and/or an adverse event data server 342 and processed or transferred to server 304. In some embodiments, a server 304 may comprise an input/output interface 306, a security module 308, and/or a display module 310. Server 304 may also comprise one or more databases or data stores, including an adverse event database 312, a medication information database 314, a literature database 316, and a variant database 318. Server 304 may, in some embodiments, comprise an analyzer 320 and/or a parser 322. In some embodiments, server 304 may comprise a global molecular entity graph 324.

Still referring to FIG. 3A and in more detail, in some embodiments, a client 300 may comprise a computing device of any type, such as a desktop computer, portable computer, smart phone, tablet computer, or any other type of computing device. Client 300 may execute an application 302 for accessing server 304. In some embodiments, application 302 may comprise a web browser, while in other embodiments, application 302 may comprise a dedicated application for communicating with server 304.

In some embodiments, client 300 may store, include, or otherwise access genomic information 303. Genomic information 303 may comprise genetic data about a patient. For example, in some embodiments, genomic information 303 may comprise a list of genetic variants or mutations of the patient, a full or partial genetic sequence, or any similar information. In some embodiments, genomic information 303 may be utilized for generating personalized drug efficacy or risk information or identifying potential drug interactions. Although shown on client 300, in many embodiments, genomic information 303 may be stored externally to client 300, obtained from a third party or stored on a second server or network storage device, or otherwise be supplied to server 304.

Server 304 may comprise a computing device of any type, such as a desktop computer, portable computer, rackmount server, workstation, or any other type of computing device. In some embodiments, server 304 may comprise a virtual machine executed by a cloud service, a plurality of servers forming a grid or server farm 38 and acting as a single server 304, or any other type of server. Although shown with components 306-324 as part of server 304, in many embodiments, one or more of components 306-324 may be external to server 304, on a second server (not illustrated), on an external storage device, or otherwise accessible to server 304.

In some embodiments, server 304 may execute an input/output interface 306. Input/output interface 306 may comprise an application, service, daemon, routine, or other executable logic for communicating with one or more clients 300 or other servers, medical literature servers 340, and/or adverse event data servers 342. In some embodiments, input/output interface 306 may comprise a web server or web page executed by a web server. Input/output interface 306 may provide an interface allowing a user to provide queries, make selections or identifications of drugs, indications, targets, pathways, or other molecular entities, define cohorts for analysis, or perform other functions. In some embodiments, input/output interface 306 may provide data tables, graphics, or other output views to the user. In many embodiments, input/output interface 306 may communicate via a network with application 302, while in other embodiments in which client 300 and server 304 comprise the same computing device, application 302 may be executed on server 304 and may communicate with input/output interface 306 via an API.

In some embodiments, server 304 may execute a security module 308. Security module 308 may comprise an application, service, daemon, routine, or other executable logic for receiving user credentials or login information and/or computing device credentials, such as a network address, operating system version or other identification, and processing the credentials to allow or deny access to server 304. Security module 308 may, in some embodiments, comprise a user and password database or similar features to control access to functions of server 304.

In some embodiments, server 304 may execute a display module 310. Display module 310 may comprise an application, service, daemon, routine, or other executable logic for generating graphic displays for presentation by input/output interface 306 and/or application 302 to a user. In some embodiments, display module 310 may generate graphs, tables, radial graphs, charts, biological network diagrams, or other graphical entities. In some embodiments, input/output interface 306 and display module 310 may be provided as part of a web server or application, while in other embodiments, these services may comprise separate executable modules.

Server 304 may include an adverse event database 312 and/or a medication information database 314. In some embodiments, adverse event database 312 and/or medication information database 314 may be stored on server 304, while in other embodiments, adverse event database 312 and/or medication information database 314 may be stored on a data storage server, external storage device, within a cloud storage system, or otherwise accessible to parser 322 and/or analyzer 320. An adverse event database 312 may comprise a database, flat file, data array, or other data file for storing molecular data regarding adverse events. Similarly, a medication information database 314 may comprise a database, flat file, data array, or other data file for storing molecular entity information for one or more drugs. As discussed above in connection with FIG. 1B, stored data may comprise identifications of one or more drugs 102, indications 104, reactions 106, outcomes 108, pathways 110, targets 112, metabolizing enzymes or transporters 114, and drug classes 116. In many embodiments, adverse event data may comprise demographic information of a patient, trial participant, or other person that experienced the adverse event. In many embodiments, adverse event data 102-108 from adverse event reporting systems may be combined and linked with molecular entity data 110-116 in the adverse event database 312 and/or medication information database 314. In some embodiments, molecular entity data 110-116 for a drug may be retrieved from pharmaceutical manufacturer literature, research literature or white papers, or other literature from one or more medical literature servers 340. In many embodiments, adverse event database 312 and medication information database 314 may comprise a single database, while in other embodiments, databases 312-314 may be linked to allow associations between entities and adverse event data. In some embodiments, associations may be one-to-one, such as a single outcome for a single patient, while in other embodiments, associations may be one-to-many, such as a plurality of prescribed and co-prescribed drugs for the patient, or many-to-many, such as a plurality of indications associated with each of a plurality of drugs. Accordingly, a adverse event/molecular entity database comprising adverse event database 312 and medication information database 314 may comprise a multi-dimensional database allowing associations between adverse events and biological information. Such a database may be used for novel univariate analyses, such as generating an ordered list of metabolizing enzymes most frequently associated with a specified side effect (by numbers of adverse event reports for the side effect or reaction including a drug, the drug associated with the metabolizing enzyme in medical literature). Similarly, such a database may be used for multivariate analyses, such as comparing reported side effects of all drugs targeting a first protein with side effects of all drugs targeting a second protein.

In some embodiments, medication information database 314 may comprise or be associated with a literature database 316. Literature database 316 may comprise a database, data array, flat file, or other data comprising one or more items of literature about one or molecular entities. Literature database 316 may comprise white papers, research papers, theses, dissertations, abstracts of literature, publicly available literature, proprietary manufacturer literature, research data, or other literature. In some embodiments, literature database 316 may comprise medication information, which may be extracted to generate a medication information database 314. In some embodiments, a server 304 may retrieve or receive literature from one or more medical literature servers 340. For example, in one embodiment, server 304 may retrieve abstracts or full papers from the PubMed database provided by the National Institutes of Health of Bethesda, Md. Such papers or abstracts may be parsed to identify drug names, drug classes, protein targets, metabolizing enzymes, transporters, gene variants or wild types, or other molecular entities. Once identified, the entities and associations between identified entities may be added to literature database 316, medication information database 314, adverse event database 312, or a combined multi-dimensional molecular data database.

In some embodiments, the server 304 may further comprise a literature database for identification of patient genetic variants or mutations, or may be associated with a variant database 318. A variant database may comprise a database, data file, flat file, data array, or other file comprising a full genetic sequence for one or more patients, clinical trial participants, or other persons, or may comprise a partial sequence, or may comprise an identification of one or more variants or mutated gene sequences for a patient, participant, or person. In some embodiments, a variant database may further comprise identifications of one or more proteins corresponding to a variant, in which expression or activation of the protein is affected by the mutation. For example, in one such embodiment, a database may comprise an identification of a variant and an identification of a protein activated by the wild type corresponding to the variant. By linking variant identifications, protein activation or deactivation, and drug target proteins, a user may identify potential decreased efficacy of a drug or high risk biological interactions.

In some embodiments, a server 304 may comprise an analyzer or analysis module 320. Analyzer 320 may comprise an application, service, daemon, routine, or other executable logic for performing univariate or multivariate analysis. In some embodiments, analyzer 320 may identify associated entities from a database, such as reactions associated with a target protein, or outcomes associated with a genetic variant. In many embodiments, analyzer 320 may generate one or more lists of associated entities based on an input or requested first entity. Such lists may be ordered, for example, by a percentage of total associations or by number of associations in the database. Accordingly, for a query of adverse reactions associated with a first drug, analyzer 320 may return an ordered list indicating that, for example, of all reported adverse reactions associated with the first drug, nausea occurs in 60% of cases, fatigue occurs in 50% of cases, and a rash occurs in 40% of cases. Due to the possibility of patients experiencing multiple adverse events, totals may exceed 100%. Similarly, for a query of targets associated with an adverse reaction such as fatigue, analyzer 320 may return a list of molecular targets ordered by proportional reporting ratio (PRR), such as dihydroorotase having a PRR of 32.91, DNA polymerase i having a PRR of 16.45, and cytochrome b having a PRR of 8.22. Such proportional reporting rations may be determined based on a proportion of reactions to the molecular entity compared to the same proportion for all such entities in the database. Taking as an input an identification of a patient indication, the analyzer may be configured to identify and output a plurality of proteins or genes associated with the indication having a co-occurrence frequency with the indication greater than a determined first threshold, e.g. 20%, 50% or 80%. The analyzer may also be configured to identify and output a plurality of genetic variants associated with the indication having a co-occurrence frequency with the indication greater than a determined second threshold, e.g. 20%, 50% or 80%. In some embodiments, analyzer 320 may further comprise functionality for performing multivariate analyses and comparisons. For example, analyzer 320 may comprise logic for extracting subsets of statistical data of adverse events associated experienced by an identified first cohort of patients or trial participants and an identified second cohort, and comparing the two subsets to identify adverse event differences between the cohorts. Phenotype or genotype distinctions between the cohorts may then be identified as the likely cause or mitigation of adverse events. Taking as an input identifications of a protein or gene and identifications of a genetic variant, the analyzer may be configured to identify and output the protein or gene as having a predominant co-occurrence frequency with identifications of the genetic variant and identifications of activation, repression, amplification or deletion. The analyzer may thus identify activation or repression of the gene or amplification or deletion of the protein by the genetic variant.

In some embodiments, server 304 may comprise a parser 322. Parser 322 may comprise an application, service, daemon, routine, or other executable logic for reading and interpreting medical literature obtained from a medical literature server 340 or stored in a literature database 316. Reading and interpreting medical literature may comprise scanning literature for identifications of one or more molecular entities. Inclusion of identifications of a plurality of entities within a single item of literature may indicate an association between those entities. Such associations may then be incorporated into a medication information database 314 and/or adverse event database 312. For example, parser 322 may scan medical literature and identify that the terms “headache” and “aspirin” frequently appear in the same items of literature. Accordingly, parser 322 may identify the indication “headache” as related to the drug “aspirin” in a medication information database 314. Similarly, in some embodiments, parser 322 may identify associations within literature between drugs, targets, transporters, metabolizing enzymes, drug classes, genetic variants, side effects, indications, reactions, outcomes, patient demographic information, or any other such information. Parser 322 may scan white papers, abstracts, articles, theses, research documents, manufacturer literature, or any other type of document for associations between molecular entities. In some embodiments, parser 322 may score the identified associations responsive to one or more factors, such as frequency, proximity, and secondary citations. For example, parser 322 may give a low association score to two molecular entities that appear in only a single item of literature once. However, parser 322 may give a higher association score to the two molecular entities, if they appear in close proximity to each other within the literature, such as in the same sentence or paragraph. In some embodiments, parser 322 may give a higher association score to associations between two entities that appear in a plurality of items of literature than an association between two entities that appears repeatedly in only a single item of literature. In such embodiments, parser 322 may thus identify associations that are commonly understood by researchers, rather than unconfirmed or proposed associations. In some embodiments, parser 322 may further identify secondary items of literature that cite a first item of literature, and give a higher score to associations identified within the first item of literature. Frequently cited literature thus may become more authoritative regarding associations.

In some embodiments, server 304 may comprise a global molecular entity graph 324. Global molecular entity graph 324 may comprise a graph, database, or other data file for identifying a plurality of molecular entities and relationships between entities. Global molecular entity graph 324 may comprise a system-wide representation of some or all biological systems within the human body. For example, referring briefly to FIG. 3B, illustrated is a diagram of an example embodiment of a global molecular entity graph 324. The graph may comprise a plurality of molecular entities 350, such as proteins, enzymes, transporters, or other entities, and each entity 350 may be associated with one or more other entities 350 via a relationship 352. In some embodiments, a global molecular entity graph 324 may be used by an analyzer 320 to extract subgraphs 354, which may comprise portions of the molecular entity graph important to a particular entity. For example, a subgraph 354 may comprise all entities and relationships between entities associated with a first identified entity, such as a drug target. In some embodiments, multiple subgraphs 354 may be extracted and compared to identify common entities and/or relationships between the subgraphs. For example, referring briefly to FIG. 3C, illustrated is a diagram of an example embodiment of two extracted subgraphs, 354a and 354b, intersected to identify an intersection subgraph 354c. A first subgraph 354a may be extracted for a first drug target (P1), and a second subgraph 354b extracted for a second drug target (P2). The intersection subgraph 354c may identify one or more molecular entities 350 affected by each of P1 and P2. These dual-affected entities may be causes of adverse effects experienced when drugs targeting P1 and P2 are taken simultaneously, but not experienced when drugs targeting P1 and P2 are taken separately. By using multivariate analysis of adverse event data and extracting subgraphs for identified entities with disparate adverse event data, server 304 may be able to identify one or more molecular entities associated with a particular side effect, even when the association would be normally hidden in univariate analyses.

Returning to FIG. 3A, in some embodiments, server 304 may communicate with a medical literature server 340 and/or an adverse event data server 342. Medical literature server 340 may comprise any server, database, online storage system, cloud storage device, offline storage system, computing device, or other device for storing medical literature, including research documents, theses, white papers, manufacturer data, or other literature. In some embodiments, server 304 may access medical literature server 340 to retrieve documents to fill literature database 316, medication information database 314, variant database 318, or for parsing one or more items of literature via parser 322 as discussed above. Similarly, adverse event data server 342 may comprise any server, database, online storage system, cloud storage device, offline storage system, computing device, or other device for storing adverse event data, such as the Adverse Event Reporting System provided by the U.S. Food & Drug Administration. In some embodiments, server 304 may access an adverse event data server 342 to retrieve records to fill an adverse event database 312 or for parsing by parser 322 or analysis by analyzer 320, as discussed above.

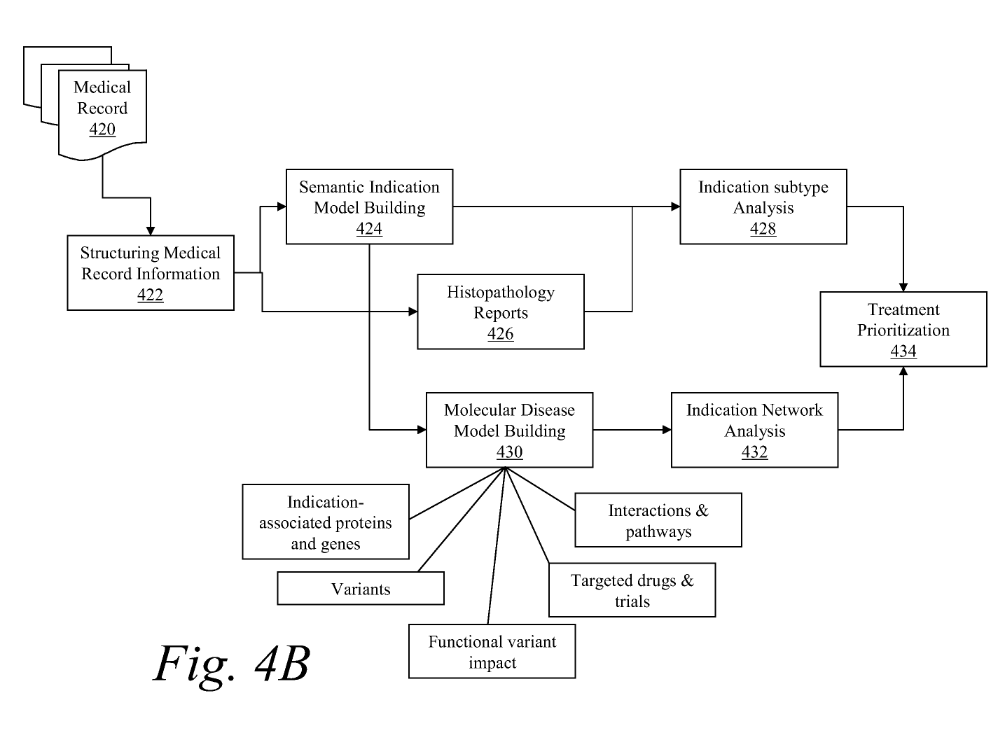

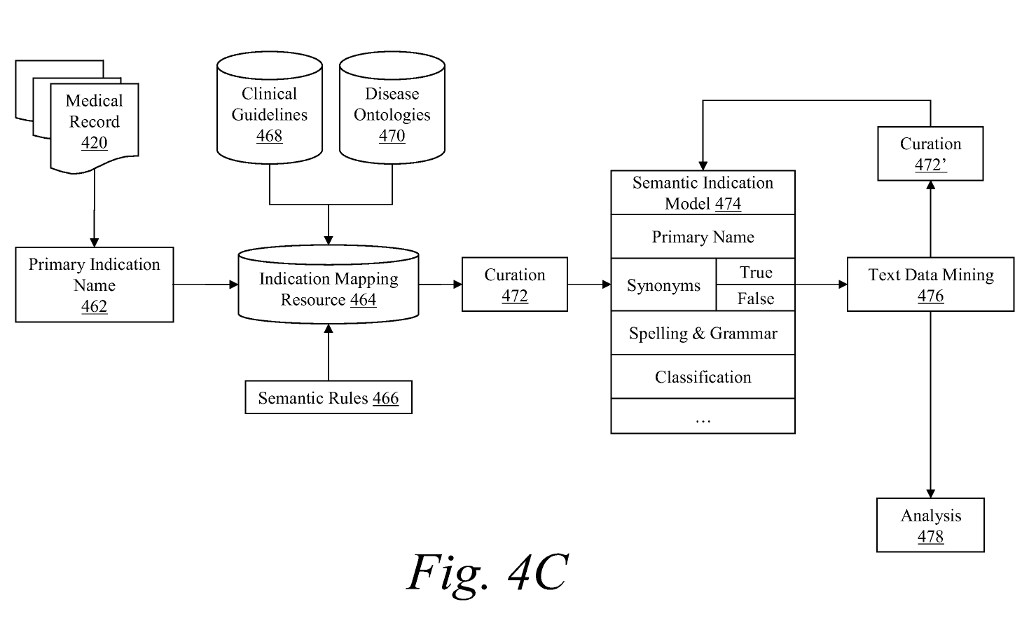

Referring now to FIG. 4A, illustrated is a block diagram of an embodiment of a system for disease knowledge modeling and clinical treatment decision support. In brief overview, information about an indication 404 of a patient 402, such as a cancer diagnosis or other disease diagnosis may be used as a search term for a parser 322, which may search available information about the indication 404 from one or more databases. Such databases may comprise, without limitation, full text journals; abstracts, such as those available on PubMed; clinical trial data; drug or medication information and target protein information, which may be provided by researchers, manufacturers, or other data sources; identifications of genes related to an indication or disease; information about pathways and interactions relevant to the disease or indication; identification of genes associated with the indication or expressing proteins associated with the indication; information regarding the standard of care of the indication, such as typical outcomes; regulatory information regarding the indication or medications associated with the indication; research reagents associated with the indication; indication information such as tumor classification and nomenclature; histology and pathology reports; or any other type and form of information. Through text mining processes, the parser 322 may identify one or more driver genes, pathways, genetic variants, drug targets, biomarkers, or other biomolecular entities associated with the indication to build a disease information or knowledge model 406. For example, in one embodiment, parser 322 may identify a protein that appears in a large number of PubMed abstracts with the indication name as likely being associated with the indication.

In some embodiments, an analyzer 320 such as an analyzer executed by a multivariate analysis system may receive clinical-molecular information about the patient 402, such as patient-specific genetic variants identified via mapping of the patient's genome, identification of medications prescribed to the patient, or other information. Analyzer 320 may use the knowledge model 406 to make evidence-based treatment decisions, such as prioritizing a list of medications to be prescribed to the patient for the indication, identifying potential combination therapies indicated or contraindicated for the patient, etc. For example, in some embodiments discussed in more detail below, analysis of knowledge model 406 may identify a plurality of protein targets associated with the indication, and analyzer 320 may identify, from a medication information database or similar data source, one or more medications affecting activity of the plurality of protein targets. Such medications may be prioritized higher than medications that affect activity of only one protein target, or no protein targets associated with the indication, for example.

Referring now to FIG. 4B, illustrated is a block diagram of an embodiment of a method for analysis of disease information for disease knowledge modeling. In brief overview, one or more patient histories, adverse event records, prescription load information, or similar medical records 420 may be analyzed and combined to generate structured medical record information 422 for the patient or indication. This may comprise normalizing the records, correcting misspellings, abbreviations, typographical errors, or otherwise preparing the records for being combined in a parseable structure for automated analysis. In one embodiment, structuring the medical record information may comprise identifying events that occur during treatment of an indication, such as the onset of symptoms, dates of surgeries, dates of radiation therapy, diagnosis of recurrences, checkups, meetings of a hospital tumor board, pathology or other tests, etc. Information may include identification of further documentation, site within the patient (which may be relevant for cancer indications or similar diseases), dates, test results, medications prescribed, adverse events, or other information.

Collecting the sparse information about rare disease entities may frequently involve text data mining approaches. Thus, at step 424, in some embodiments, the analyzer may build a semantic indication model, or a precisely defined semantic framework for the indication to facilitate text data mining. For example, referring briefly ahead to FIG. 4C, illustrated is a block diagram of an embodiment of a system for building a semantic indication model 424. A primary indication name 462 may be identified in patient medical records 420, and used as an input to an indication mapping resource 464. Indication mapping resource 464 may comprise an application, server, service, daemon, or other executable logic for retrieving clinical guidelines 468 and disease ontologies 470 corresponding to identified indication 462 from databases or storage devices, and applying one or more semantic rules 466 to create a unified semantic model of the indication. For example, the World Health Organization classifies the rare and invasive malignant peripheral nerve sheath tumor (MPNST) as a “tumor of the central nervous system,” distinct from, but related to schwannoma, neurofibroma, and peurineurioma, based on MPNST's association with neuroectodermal, central nervous system-derived structures. By contrast, the National Comprehensive Cancer Network (NCCN) classifies MPNST as a “soft tissue sarcoma” (STS) of mesenchymal origin, based on gene-expression based indication clustering. Accordingly, a system that can identify and integrate records relating to each classification can facilitate a richer understanding of the indication than one that views the WHO and NCCN classifications as distinct and unrelated. The indication mapping resource may be used to identify true indication synonyms, such as abbreviations compared to full names; closely related indications (e.g. malignant schwannoma); distantly related indications (e.g. synovial sarcoma); and indication superfamilies (e.g. soft tissue sarcoma or STS). In some embodiments, an administrator or researcher may perform curation 472 on the indication mapping, to prevent false positive or negative correlations between terms. The knowledge model building system may then generate a semantic indication model 474, identifying the indication name 462, synonyms for the indication, alternate spellings, classifications, or any other data relevant to the indication. Through further text data mining 476 of available literature, such as PubMed abstracts, drug manufacturer information, clinical trial publications, or any other data, additional information about the indication may be retrieved and added to the semantic indication model 474, including identification of relevant or important biomolecular entities, pathways, or related systems. In some embodiments, the retrieved data may be further curated 472′ to identify false positives or negatives. The semantic indication model 474 may then be used for further analysis 478 for prioritizing therapies.

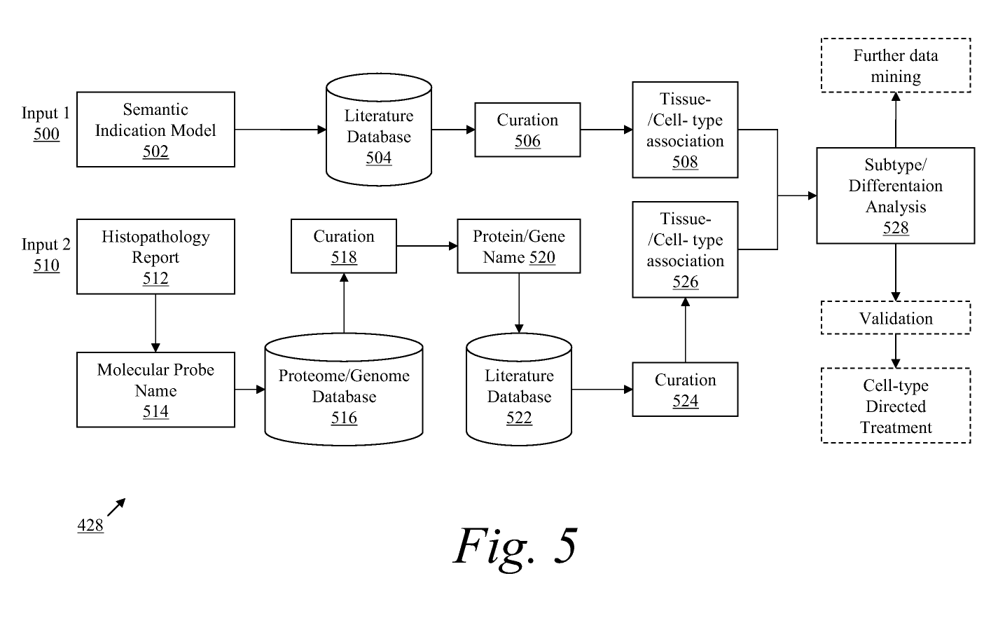

Returning to FIG. 4B, in some embodiments, the semantic indication model 424 may be provided for indication subtype analysis 428. For example, given the cancer type MPNST, various phenotypic differentiation patterns may occur, including rhabdomyoblastic, perineurial, angiosarcomic, glial, cartilaginous, or others. Thus, although classified as a single tumor type, MPNSTs may have diverse histogenetic origins, reflecting the tissue- and cell composition of the peripheral nerve sheath. Accordingly, it may be valuable to further analysis and classify relevant indication subtypes when prioritizing treatment decisions. Referring now to FIG. 5, illustrated is a block diagram of an embodiment of a system for utilizing semantic indication models and histopathology reports for differentiation analysis 428 of a disease knowledge model. In brief overview, the semantic indication model 502 may be used as a first input 500 and a histopathology report of the patient 412 may be used as a second input 510 for differential analysis. The model 502 may be used to retrieve information from a literature database 504, as discussed above. For example, the model 502 may provide keywords for searching within literature for additional information, associated biomolecular entities, or other associations. As discussed above, at 506, in many embodiments, an administrator, user, or researcher may curate the retrieved data to remove false positives or negatives. At 508, the analyzer may determine a tissue- or cell-type association for the indication based off of the retrieved literature.

Similarly, with input 2, patient histopathology 512 may be parsed to identify all molecular probe information 514 for mapping to unified human gene/protein names 516, which, in some embodiments, may be curated 518 to remove any false positives or negatives. For each identified protein/gene name 520, a literature database 522 may be parsed to identify cell-type or tissue-type expression information 526. In many embodiments, steps 522-526 may be similar to steps 504-508, with different inputs based on histopathology report 512 as opposed to semantic indication model 502. Differences between the outputs 508, 526 given the two inputs may be determined and analyzed at 528, and may be used for further data mining or for directed treatment and prioritization, as shown in step 434 of FIG. 4B.

Referring back to FIG. 4B, given the semantic indication model produced at 424, a molecular disease model may be built from information regarding indication-associated proteins and targets; genetic variants, including identification of functional impacts of variants such as activation or inactivation of a protein; targeted drugs and clinical trials; and interactions with pathways and other molecular entities. As discussed above, this information may be mined from relevant literature, as well as extracted from a global molecular entity graph, to generate a network of entities associated with the indication 432. This network may be analyzed to identify targets most likely to be associated with the indication, such as targets highly interconnected within the network or targets closely associated with the organ affected by the indication.

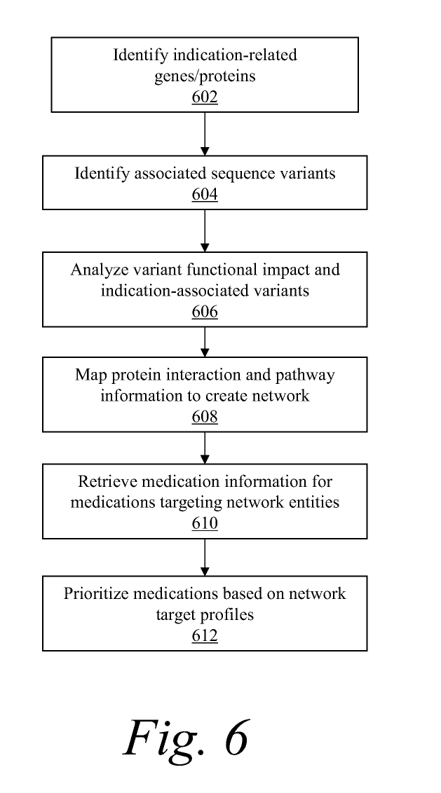

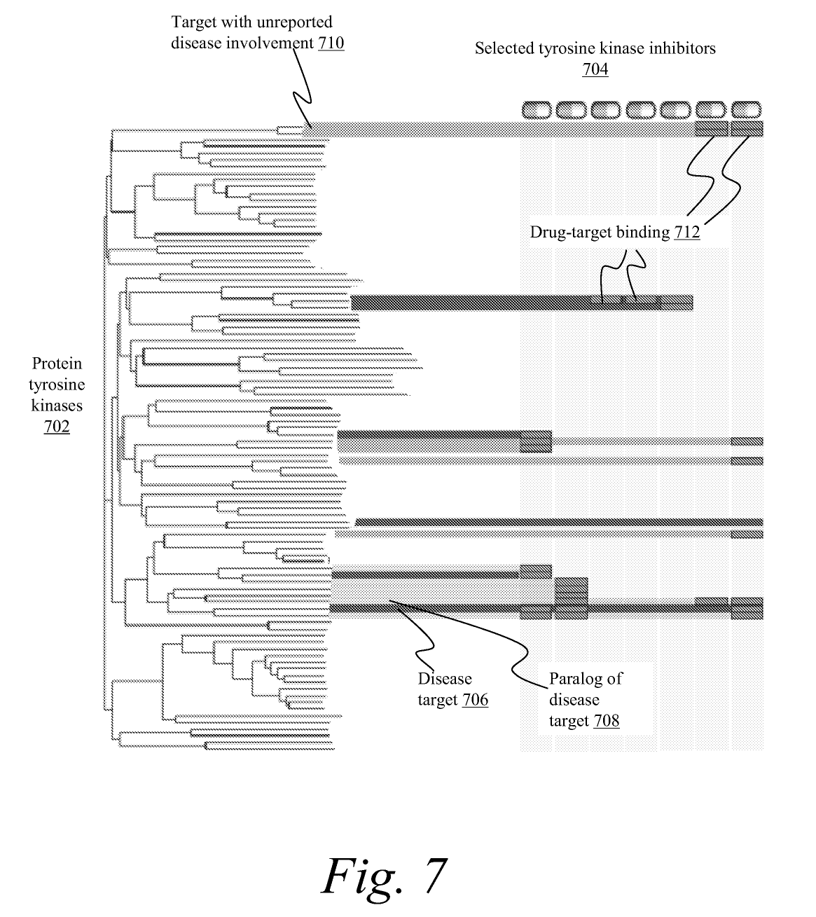

Referring now to FIG. 6, illustrated is a flow diagram of an embodiment of a method for prioritizing treatment decisions. In brief overview, at step 602, an analyzer module executed by a multivariate analysis system may identify indication related genes or proteins for a specified patient indication. The specified patient indication may be retrieved by the analyzer from a database, may be selected by a user or physician, or otherwise entered. At step 604, the analyzer may identify genomic or genetic sequence variants associated with the indication. At step 606, the analyzer may determine variant functional impact and indication-associated variants, and may select a subset of the plurality of proteins or genes responsive to the identified functional impact of the genetic variant on the protein or gene associated with the patient identification. At step 608, the analyzer may map protein interaction and pathway information to create an indication-specific molecular entity network. At step 610, the analyzer may retrieve, from a medication information database, medication information for medications targeting network entities in the indication-specific network. At step 612, the analyzer may prioritize medications based on network target profiles or generate a prioritized list of suggested treatments, each comprising one or more of the medications. The priority of each suggested treatment may be based on a number of targets in the indication-specific molecular entity network affected by the one or more medications of the suggested treatment.

Still referring to FIG. 6 and in more detail, at step 602, an analyzer executed by a multivariate analysis system, such as those discussed above, may identify indication-related genes or proteins for a specified patient indication. In some embodiments, the analyzer may receive an identification of the indication from a user. In other embodiments, the analyzer may retrieve the identification of the indication from another computing device or storage device. The analyzer may perform text mining and statistical analysis of literature to find and prioritize genes and protein terms identified in documents associated with the indication, such as a co-occurrence frequency analysis. The documents may comprise medication information, clinical trial information, PubMed abstracts, white papers, research papers, thesis papers, adverse event data or records, or any other type and form of documents. In many embodiments, the analyzer may identify all molecular entities studied in the disease-context, irrespective of a causative contribution, thus including histological markers, general indication markers, indication-specific markers, indication-specific gene candidates, known associated proteins or pathways, or any other entities. In many embodiments, the identified molecular entities may include factors involved in indication-related tissue and cell biology, known or currently assumed disease genes and proteins, candidate drivers of various forms of the indication, and entities that have been merely suggested to be causally involved.

At step 604, the analyzer may identify genetic sequence variants associated with the indication. In some embodiments, similar to step 602, the analyzer may parse literature for a co-occurrence frequency analysis of genetic variants identified in documents associated with the indication. This may allow for identification of candidate disease genes, including drivers of the indication, passengers or correlated genes that may lack a direct causal link, or structural genomic aberrations indicative of or involved in the indication.

At step 606, the analyzer may determine variant functional impact and indication-associated variants. In some embodiments, the analyzer may identify gene ‘activation’ or ‘amplification,’ or ‘repression’ or ‘deletion’ associated with the identified variants, and a mechanistic contribution to the indication. For example, variants that cause inactivation of a protein and a causal link between deactivation of the protein and the indication may be identified. In some embodiments, the analyzer may identify this impact via literature, while in other embodiments, the analyzer may parse a global molecular entity graph or subgraph associated with the indication and identify proteins relevant to the indication with functions affected by the identified genetic mutation. In some embodiments, the genes identified to have a mechanistic contribution to the indication may be selected as a core entity set for the molecular disease model. The analyzer may select a subset of the indication-related genes or proteins responsive to the identified functional impact of the genetic variant on the protein or gene.

At step 608, in some embodiments, the analyzer may map protein interaction and pathway information to create or generate an indication-specific molecular entity network. As discussed above, the analyzer may extract a subgraph from a global molecular entity graph or may generate a subnetwork from a global molecular entity array comprising the identified core entity set. Protein-protein interactions, molecular pathway information, or other relevant information may be used to construct a network model associated with the indication. This may allow for identification of potential epistatic effects of drug targets and variants. In some embodiments, where pathways or indication relevant cellular processes are known, the analyzer may add molecular mediators, effectors, or paralogous proteins to the model.

At step 610, the analyzer may retrieve, from a medication information database, medication information for medications targeting network entities in the indication-specific network. In some embodiments, the analyzer may search a medication information database for medications that are associated with or mapped to targets identified in the indication-specific network. The identified medications may be prioritized according to stage and indication of development, for example, using the synonyms and classification of the indication within the semantic indication model. In some embodiments, the medication information database may be augmented through retrieval of information about medications under development or testing, or in clinical trials related to the indication or similar indications.

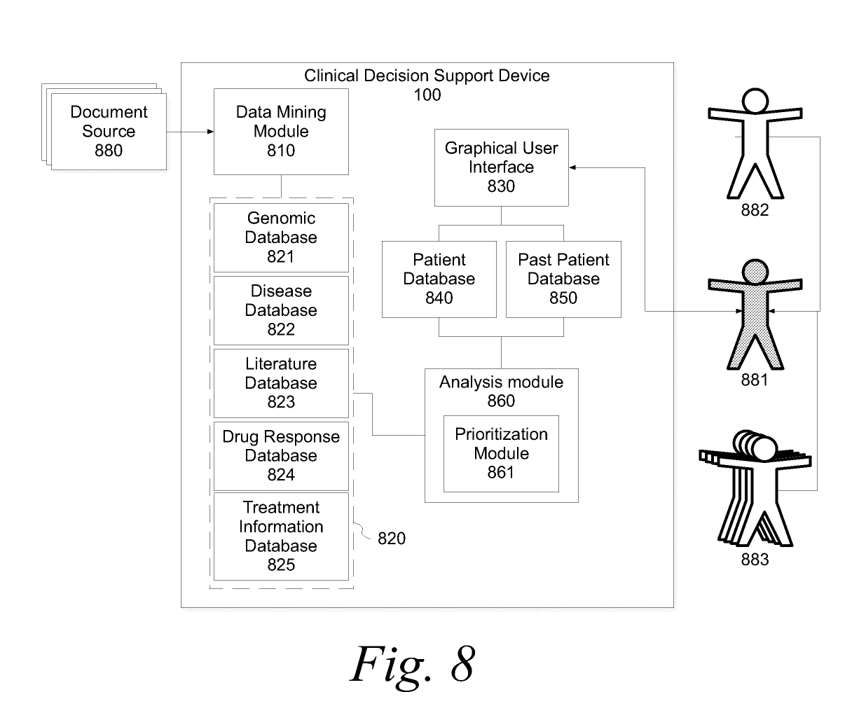

At step 612, the analyzer may prioritize medications based on network target profiles. In one embodiment, medications identified at step 610 may be mapped against their targets in a phylogenetic tree of molecular entities, such as protein tyrosine kinases or similar elements associated with the indication. In some embodiments, medications that target a plurality of entities associated with the indication may be prioritized higher than medications that target only one entity. In other embodiments, a set of medications may be selected for combination therapy based on non-overlapping target profiles between the medications, with the combination targeting a high number of indication-specific amplified or over-expressed proteins or genes. For example, referring to FIG. 7, illustrated is a tree diagram of an exemplary disease model and prioritized medication information. As shown, a phylogenetic tree 702 of protein tyrosine kinases and their relationships may be provided with medications 704 identified by their target bindings 712 to relevant disease targets 706, paralogs of disease targets 708, and/or targets with unreported disease involvement 710 identified from the indication subnetwork, associations in published literature, multivariate analysis of adverse event data, or other means. Medications may be selected and prioritized such that the largest number of targets 706-710 are affected with the fewest number of medications. For example, given four targets, a medication targeting all four would have a higher priority than a medication targeting just one. Similarly, a combination of a medication targeting the first two targets and a second medication targeting the second two targets may be prioritized over a combination of four medications each targeting one target.

In summary, computational disease knowledge modeling may be used to provide evidence-based treatment prioritization for indications, particularly rare or poorly understood indications. Computational data mining can additionally aid in aggregating important up-to-date information on standard of care and assist indication subtype analysis.

### Clinical Decision Support Device

The rapid advancement of high-throughput technologies available for generating large-scale molecular-level measurements in human populations has led to an increased interest in the discovery and validation of molecular biomarkers in clinical research. Biomarkers are generally defined as any “biological characteristic that is objectively measured and evaluated as an indicator of normal biologic processes, pathogenic processes, or pharmacologic responses to a therapeutic intervention”. Various types of biomarkers may include genomic biomarkers (e.g. single nucleotide variations (SNV), copy number variations (CNV), insertions, deletions, gene fusions, polyploidy, gene expression, miRNA's), proteomic biomarkers (e.g. post-translational modifications, expression), metabolites, electrolytes, physiological parameters (e.g. blood pressure), patient age, patient weight, or patient co-morbidities. Uses of biomarkers for clinical decision making is quite varied and includes identification of predictive and prognostic factors for disease management, surrogate endpoints for monitoring clinical response to an intervention and early detection of disease.

In oncology, for example, tumor biomarkers may be used to determine a patient's current clinical status and to predict disease drivers and mechanisms that might be modified by specific therapeutic interventions. These so-called “predictive biomarkers” usually represent somatic changes that have emerged during the process of carcinogenesis and can be detected in cancer or healthy tissue, in secretions, and circulating in blood. Predictive biomarkers can also be inherited germ-line variations that can also predict differential uptake, distribution, metabolism, and thus response to a drug, such as is possible for certain chemotherapeutic agents.

While the discovery of potential predictive biomarkers continues at pace, very few have actually made it to a point of endorsement for routine clinical use. This is primarily due to the fact that the transition from the discovery of a potential predictive biomarker to one with endorsed clinical utility is long, expensive and holds much in common with the requirements of drug development. As a result, there exists a large “portfolio” of poorly validated biomarkers, ranging from those that might be very helpful in personalizing cancer care (but whose clinical use is currently limited), to those with unproven clinical utility that are being used to manage care, (sometimes to the detriment of patient outcomes).

Biomarker information may be captured from various sources, including published literature, drug manufacturer information, FDA adverse event reports, or other sources, as well as from the patient or from records of past patients. Once the prevailing attributes of such information have been captured in a database, they can be used to assess the clinical actionability of any genomic variation identified in a specific patient case. Such assessment considers the clinical validation level of a biomarker (i.e. whether it has been observed clinically, pre-clinically or computationally inferred) in combination with other factors such as:
The availability of the associated treatment in the patient disease;
Whether the biomarker predicts response, resistance or risk;
Whether it was observed in the current patients disease or not; and
Genomic parameters that tell us about the reliability of the variant called and the degree to which it occurs within the disease.

Summed together, this scoring schema can in turn be used to uncover and prioritize the most reliable biomarker information present in a patient genome, which in turn can prioritize the next best treatment options. Such treatment options may include targeted therapy, chemotherapy, surgery, radiation, laser ablation, vaccination, biological therapy, Immunotherapy, Stem Cell Transplant, Transfusion, Transplantation (e.g. bone marrow), Hyperthermia, Photodynamic therapy, nutritional adjustment (e.g. fasting), or physical exercise.

In brief overview, in some implementations, one or more steps are performed to convert tumor-sequencing data or data about other indications into clinically actionable information, including:
Alignment of the sequence reads coming from tumor and germline to reference genome;
Identifying genomic variants associated with germline and tumor independently;
Assessing the difference between germline and tumor variations to determine tumor specific variants;
Mapping these variants to the proteome to identify coding variants;
Comparison of the variants against a drug response database (DRDB) to ascertain if they may be previously described predictive biomarkers. This process allows users to assess how current biomedical knowledge surrounding predictive biomarkers relates to the mutations identified in the patient tumor;
Assessing the functional effects of these variations by applying a functional impact methodology. This “functional impact scoring” evaluates and predicts the functional effects of genetic variations at the single protein- and molecular network level;
Aggregating, integrating and collating the complete and up-to-date canon of relevant biomedical knowledge on protein function and biological context, disease mechanisms and drug mode of action in an indication specific manner; and
Utilizing this combined information for the prioritization of drugs or other treatments.

These approaches allow in-depth analysis and clinical interpretation of cancer genomes, supporting physicians in the demanding task of cancer drug prioritization for their patients on the basis of a genomic tumor profile. Via genome-wide detection and prioritization of tumor-specific gene sequence variants from single patient case samples, treatment prioritization may be based on integrating all indication-relevant information with confidence or knowledge scores, which can be applied to proteins/genes. This method allows directly assessing the treatment-relevance of all patient variants in protein coding genes.

### Detection of Tumor-Specific Genomic Variants

In some implementations, the system allows for a fully automated workflow/pipeline for the detection of tumor-specific (somatic) non-synonymous single nucleotide variants (SNVs) in tumor-normal paired exome sequencing data sets. Variant detection occurs in a two-step process: (1) sequence alignment and (2) variant calling. The first step involves the global optimal alignment of sequence reads to the most current assembly of the human genome. Sequence reads can be de-duplicated prior to this step in some implementations.

In the second step the alignments from the tumor-normal paired sequence data set are used to call genomic sequence variants. Based on pre-set cut-off values for variant calling metrics, the set of detected tumor-specific genomic variants may be further processed for prioritization via ‘functional impact scoring’ or scoring of importance of a variant to an indication or tumor, discussed in more detail below.

### Prioritizing Variants According to Variant Call Properties

In the course of detection, variants are annotated with technical parameters that reflect the quality of the genomic call such as allele frequency and genome probability. These parameters can be used complementary to functional impact scoring or importance scoring to prioritize variants. This also includes the classification of variants into ‘missense’ (causing an amino acid exchange) and ‘nonsense’ (introducing a premature STOP codon).

### Relating Genomic Variants to Reference Genes/Proteins

In some embodiments, the system may map all detected genomic variants unambiguously to reference proteins. This allows the prioritization of genomic variants based on any protein-centric information, e.g. the collective cancer or indication-relevant attributes of the affected protein. In addition, the mapping supports the precise association of genomic variants with sequence-position-based structural-functional features and annotations of proteins. This association may be used to determine the known or predicted impact of the precise mutation on the generic biological activity/function of the protein (referred to ‘functional impact scoring’).

### Prioritizing Cancer-Relevant Genes/Proteins in an Indication Specific Manner.

In some implementations, the system collates clinically relevant information for the complete human proteome across various knowledge domains and, in some embodiments, is specifically tailored to oncology. In addition to capturing oncology-wide knowledge across all cancer types, for example, it may use specific indication information from the patient under analysis. The collated information is used to compute a score for each protein, which directly reflects its importance for cancer in general and the cancer type under consideration. Similar steps may be applied for other indications or subtypes. The method enables the reliable prioritization of genomic mutations in proteins that are key to the particular cancer or indication including drug targets, disease drivers, oncogenes, tumor suppressors and other molecular entity types.

Importantly, this relevancy score rates the cancer or indication-relevance of a protein independent of the occurrence of a genomic variant in the protein in a concrete patient case. Thus, if a previously unknown genomic variant is detected in a tumor and cannot be assessed for its potential effect on the basis of the molecular nature of the exact mutation (by ‘functional impact scoring’, discussed in more detail below), it can still be rated based on the relevancy information.

In many implementations, the relevancy information is associated with a protein or gene and thus, if used for variant prioritization, may be equally applicable or transferred to all variants of the respective protein or gene.

### Functional Impact Scoring

Functional impact scoring (FIS) serves to prioritize variants based on their effect on protein function. The FIS of a variant is determined independently of the cancer or indication relevancy of the associated protein or gene. In contrast to the relevancy score, which may be globally assigned to a protein/gene in some embodiments, the functional impact score may be uniquely associated with the specific variant of a protein or gene (including position and exchange). Distinct variants of the same protein or gene may have different functional impact scores, while in many implementations, a protein or gene may have just a single relevancy score.

The functional impact score allows measurement of the effect of the detected genomic variant on the function or activity of the associated protein. Complementary to the relevancy score, which allows prioritizing variants in cancer or indication-relevant proteins or genes (irrespective of the effect of a specific genomic variant), the functional impact score allows identifying and prioritizing variants that have a high likelihood of creating net effects on the biological function of proteins. The scoring method is based on categorizing variants and rating the type and amount of supporting evidence in the respective category.

### Process for Building the DRDB

In one implementation, each variant detected in a patient is first compared to a drug response database (DRDB) that categorizes biomarker data. In some implementations, the comparison may be restricted to matching non-synonymous SNVs (missense and nonsense mutations) detected in patient tumor exomes or similar data. The DRDB may be built via text data mining and curation.

The raw DRDB data may be provided via text data mining from various publications, including medical journals, drug manufacturer data sheets, clinical study results, or any other such data. This data may be curated via a multi-step process to ensure high-quality data. Curation may be performed by a plurality of experts, who may perform cross reviews of the data for clinical-approved (e.g. endorsed) or clinical biomarkers according to curation guidelines.

### Description of Information Captured in the DRDB

In some implementations, the drug response database may capture some or all of the following information, which may be used in defining the evidence level that can be attributed to a particular biomarker:
The Variant—type of aberration;
The drug or treatment used;
The observation context (e.g. patients (disease, disease stage) or model system);
Effect on drug or treatment responsiveness;
Type of response;
Quantity of effect; and
Validation level.

Specifically, the database may include information about any form of genomic aberration including Single Nucleotide Polymorphisms (SNV's), Copy Number Variations (CNV's), Fusion Proteins (FP's), Insertions and deletions (InsDels). Each variant may also be identified by a role, such as primary for variants in cell lines or for primary mutations in patients and secondary for secondary mutations. The lineage of the mutation may also captured, for example, whether it is a germline or somatic mutation.

Similarly, the database may include information about the drug or treatment associated with the biomarker (i.e. variant) being reported, as well as information about the context in which the biomarker observation was made—for example, in model systems or patients. This information may include MeSH terms or other hierarchical classifications.

In some implementations, the database may also include indication specific information, such as tumor stage, the extent of the cancer, size of tumor, or presence of metastasis. For most solid tumors, for example, there are two related cancer staging systems, the Overall Stage Grouping, and the TNM system, and their classification may be included in the DRDB. Tumor stage (I-IV) may also be included, as well as site of metastasis. Other information may include in vitro model information, such as cell line identification.

Information about drug or treatment response may also be included in the DRDB, including whether the variant confers increased responsiveness to treatment, resistance to treatment, or a risk of adverse events when a treatment is applied, as well as degree of sensitivity or quantity of the effect or clinical response.

In some implementations, the DRDB may also include information about validation levels, including clinically approved or endorsed variants; clinically observed variants including in prospective, retrospective, or other studies; or pre-clinically reported variants observed in in vitro systems.

Now referring to FIG. 8, illustrated is a block diagram of a system for disease knowledge modeling and clinical treatment discussion support. In brief overview, the Clinical Decision Support Device (CDSD) 100 mines data from knowledge sources and then recommends and prioritizes treatment options based on patient characteristics and available knowledge about the disease. In some implementations, the CDSD's data mining module 810 retrieves data from at least one data source 880. The mined data is storage in one of a plurality of mined databases 820. The databases may include a genomic database 821, a disease database 822, a literature database 823, a drug response database 824, and a treatment response database 825. In some implementations, the CDSD 100 includes a graphical user interface (GUI) 830 that allows a clinical user 881 to input patient 882 and past patient 883 data into a patient database 840 and past patient database 850, respectively. Responsive to a request for clinical decision support, the analysis module 860 retrieves data from the plurality of databases to calculate possible treatment options. The prioritization module 861 then prioritizes the treatment options based on patient specific data and data within the plurality of databases.

Still referring to FIG. 8, and in greater detail, in some implementations, the CDSD 100 may be a computing device of any type, such as a desktop computer, portable computer, smart phone, tablet computer, or any other type of computing device. In some embodiments, the plurality of databases may be housed in a second computing device, such as a data server.

The CDSD 100 may include a GUI 830. The GUI may allow a clinical user 881 to input patient data, past patient data, mine data, request clinical suggestions, or any combination thereof. For example, the clinical user 881 may be a doctor that inputs a patient's data into the system. The doctor may then request possible treatment options based on the type of disease the patient has and the knowledge gathered from the document sources 880 by the data mining module.

In some embodiments, the CDSD 100 may include a data mining module 810 that mines at least one document source 880 for data. Data mining module 810 may comprise an application, service, server, daemon, routine, or other executable logic for scanning and extracting information from data sources. The document source 880 may be a repository of scientific journals, a database such as PubMed, or other such source of scientific literature. The data mining module 810 may employ computational linguistic to extract text data from the document source 880. In some implementations, the data mining module seeks to find links between genomic variants, biomarkers, diseases, and drugs. The data gathered from the mining of the document source 880 is stored in plurality of mined databases 820. In some implementations, the data mining occurs on a second device and the second device provides the CDSD 100 with mined databases 820, or in other implementations, the CDSD 100 accesses the plurality of mined databases 820 that are stored on the second device. For example, the CDSD 100 may be a client type computing device. A server may continually mine new document sources 880 and provide the client CDSD 100 with updated mined databases 820 at regular intervals. In some implementations, biomarkers may be Genomic (e.g. single nucleotide variations (SNV), Copy number variations (CNV), insertions, deletions, gene fusions, polyploidy, gene expression, miRNA's), Proteomic (e.g. post-translational modifications, expression), metabolites, electrolytes, physiological parameters (e.g. blood pressure), patient age, patient weight, patient co-morbidities. In some implementations, the term drug may be used interchangeably with the term treatment, as the systems and methods discussed herein may be readily applied to non-drug based treatments. In some of these implementations, treatments may include: targeted therapy, chemotherapy, surgery, radiation, laser ablation, vaccination, biological therapy, Immunotherapy, Stem Cell Transplant, Transfusion, Transplantation (e.g. bone marrow), Hyperthermia, Photodynamic therapy, nutritional adjustment (e.g. fasting), physical exercise.

The CDSD 100 may include a past patient database 850. In some implementations, the past patient database 850 is a record of the current and/or past patients input by the clinical user. The record may include the disease, variant, and treatments of past patients. In some implementations, this information may supplement the mined databases 820 when clinical decisions are made. In other implementations, the past patient database 850 includes data from a plurality of CDSDs 100. For example, a CDSD 100 may save anonymized patient data to a central database. The anonymized data may be accessed by a network of CDSDs 100 when providing clinical support.

The genomic database 821 may store genomic information mined from the document sources 880. In some implementations, the genomic information may include a list of genetic variants or mutations, full or partial genetic sequences, or any such similar information. The genomic information may be associated with one or more diseases, conditions, or indications stored in a list in the disease database 822. In some embodiments, the variants are categorized as having a risk, response, or resistance when associated with a drug or treatment listed in the drug or treatment response database 824. For example, if a patient presents with a specific type of cancer and a specific genetic variant, the variant may make it such that the drug has no effect on the cancer. Similarly, some genetic variants may place the patient at high risk when consuming a particular drug compared to the general population.

In some implementations, a plurality of validations is associated with the information stored in the genomic database. The mined variant data may be clinically validated and/or have a validation context. In some implementations, the clinical validation includes a tier of validation. The tiers may include or represent that the biomarker is “endorsed by key opinion leader”, “clinically observed”, “pre-clinically observed”, or “inferred”. Key opinion leader validation may come from sources such as the Food and Drug Administration (FDA), American Society of Clinical Oncology (ASCO), or other such organizations. This type of validation may occur when the key opinion leader has issued a report or endorsement of a correlation of a biomarker with an indication or treatment as causing a specified response or outcome. Clinically observed validation may occur when variant-disease-drug-drug response links have been seen clinically, and the findings have been published in peer-reviewed journals or in conference abstracts, for example. Pre-clinical validation may occur when variant-disease-drug-drug response links have been observed in pre-clinical models, such as animal models, of the disease. Inferred validation may occur when variant-disease-drug-drug response links have been observed in computer models of the disease, or based on the similarity of a novel biomarker to a known predictive biomarker (e.g. BRAF V600D might be inferred to have a similar predictive effect to BRAF V600E). Additionally, the context of validation and its relationship to the current patients disease may be assessed. For example, the context may be that the link was observed in the same disease as the patient currently under treatment. A second context may be that the link was observed in another disease similar to the disease of the patient. In some implementations, rankings are associated with each of above described validation tiers and contexts. In other embodiments, other tiers may be utilized, such as “guideline” for treatments that have been published as a standard treatment guideline for an indication. In some implementations, if a standard treatment guideline exists, such treatments may be prioritized over others as a default rule.

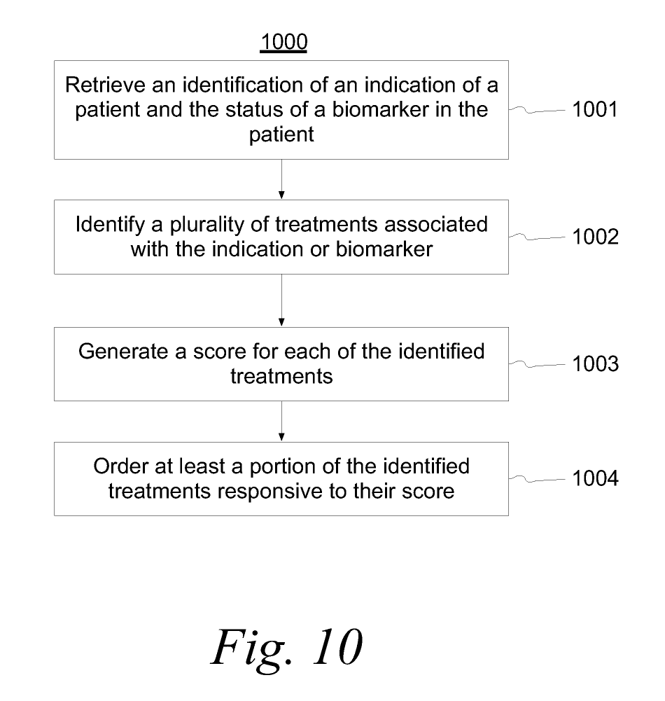

Discussed further in relation to FIG. 10, but briefly, in some embodiments, the analysis module 860 may be utilized for generating personalized drug efficacy or risk information or identifying potential drug interactions. Analysis module 860 may comprise an application, service, server, daemon, routine, or other executable logic for analyzing biomarker and patient information, generating or aggregating a score for one or more proposed treatments based on patient-specific and biomarker information, and generating an ordered list of prioritized treatments for a patient. In some implementations, the analysis module 860 determines whether a variant or other biomarker discovered in a patient should be applied in the clinical support process. The decision to apply the biomarker may be made by applying a plurality of predefined criteria. For example, the analysis module 860 may apply one, or any combination, of the following criteria: degree to which the variant has been clinically validated to affect the drug effect; whether clinical validation occurred in the patient disease or some other disease; availability and/or approval of medication in patient indication; reliability of the variant call in the patient measurement; percentage of reads in which variant is detected in the patient sample; what type effect is the biomarker associated with (e.g. response, resistance, or risk); and measure of how strongly the a drug effect is altered on average in comparison to patients without the biomarker. In some embodiments, as shown, analysis module 860 may comprise or execute a prioritization module 861, which may comprise an application, service, server, daemon, routine, or other executable logic for scoring and/or prioritizing scored treatments, as discussed above.

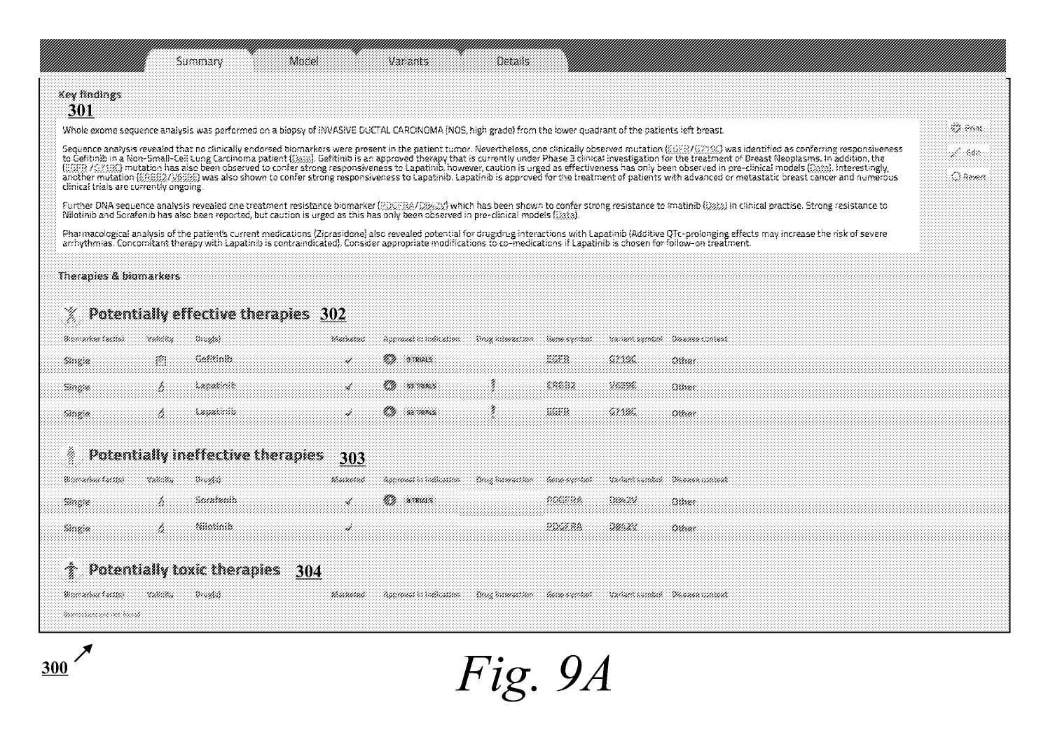

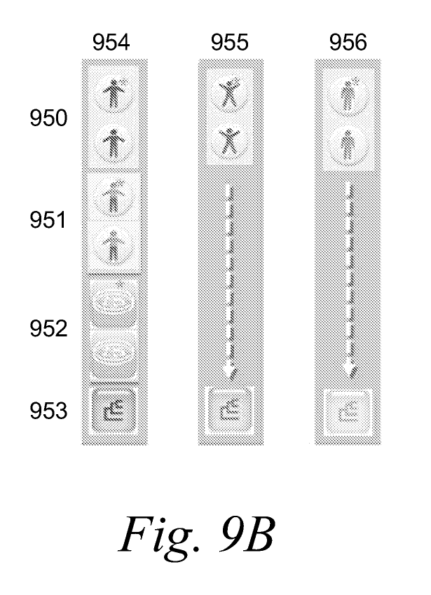

Now referring to FIG. 9A, illustrated is an exemplary embodiment of GUI 830 for the CDSD 100. The GUI 830 may include a number page views 900. The page view 900 may include a summary section 901. In some implementations, as shown below the summary section 901 in the example screenshot, prioritized treatment options (discussed further in relation to FIG. 10) may be displayed. The treatments may be grouped as a potentially effective therapy 902, a potentially ineffective therapy 903, and/or a potentially toxic therapy 904.

Still referring to FIG. 9A, and in greater detail, in some implementations, a clinical user may be presented with a summary section 901. The summary section 901 may provide the clinical user with an overview of a patient's medical record. In some implementations, the summary section 901 may list specific variants found in the patient's cells or other medical information relating to genomic information. In some implementations, the summary section links directly to third party digital medical record systems, such that the information from the disclosed system may be viewed in the patient's clinical, digital chart. In many implementations, summary 901 may be generated dynamically by the analysis engine responsive to results of analysis and prioritization of treatments, patient history analysis, or other information. For example, text strings with variables may be pre-written and may be dynamically selected and added to the summary.

As discussed above, the treatment options may be tiered as responsive, resistant, or risk. In some implementations, the responsive, resistant, and risk tiers are mapped to the GUI sections potentially effective therapy 902, potentially ineffective therapy 903, and potentially toxic therapy 904, respectively.

In some implementation, the therapy sections provide information relating to biomarker facts, validity, drug name, approved for indication, drug interactions, gene symbol, variant symbol, disease context, or any combination thereof. For example, under the potentially ineffective therapies 903 section for a particular patient, two drugs are listed Sorafenib and Nilotinib. For each drug, under validity, an icon indicates at what stage the drug has been validated. For example, the microscope icon may indicate the drug has only been validated in pre-clinical studies. Also as shown in the exemplary embodiment of page view 900, it is indicated that Sorafenib has been indicated in 8 clinical trials for this particular indication. The CDSD 100 may determine this information via the data mining module's 810 analysis of the document sources 880. In some implementations, a plurality of icons may be used to quickly and effectively relay information to the clinical user. The icons may be selected to reduce confusion and aid in the ease of determining which treatment option may be the most effective for a particular patient.

For example, FIG. 9B, illustrates one set of icons that may provide the user with additional information, according to one exemplary embodiment. FIG. 9B illustrates a set of icons that may provide a clinical user with information regarding the validity of variants. As illustrated in FIG. 9B, icons 954 associated with risk may be colored red, icons 955 associated with response may be colored green, and icons 956 associated with resistance may be colored grey. Additionally, in some implementation, the above described clinical validity and validation context may be represented in the icon. For example, the icon group 950 illustrates a figure fully colored. This may indicate that the clinical validity of the response type has been endorsed by a key opinion leader such as the FDA. In some implementations, each of the icon sets may include an asterisk, or other indicator, if the validation context was the exact validation context of the patient. For example, a fully red colored figure with an asterisk, may indicate that, based on a fixed drug treatment, the variant indicates a risk to the patient, the variant has been validated in the patient's exact disease, and the validation has been endorsed by an organization such as the FDA. The various figures and icons thus may be used to quickly communicate likely result of a treatment, as well as statistical or inferred confidence in the result.

In some implementations, there may be an icon for each type of clinical validity. For example, variants that have been validated through clinical observation may be represented as an icon figure half colored 951; variants that have been validated through pre-clinical models may be represented as an icon of cells in a Petri dish 952; and variants that have been inferred through models may be represented as genetic map icon. Though described above as having a specific color, icon or indication, the above examples were provides only as an exemplary embodiment. One of ordinarily skilled in the art will recognize and appreciate the various ways the above icons may be colored, indicated, or otherwise represented.

FIG. 10 is a flow chart illustrating a method 1000 for delivering clinical decision support according to one exemplary embodiment. In general, the analysis module retrieves an identification of an indication of a patient and the status of a biomarker in a patient (step 1001). The analysis module then identifies a plurality of treatments associated with the biomarker or indication (step 1002). Responsive to identifying the treatments, the analysis module generates a score for each of identified treatments (step 1003). Then the possible treatment options are prioritized and displayed to a user (step 1004).

At step 1001, the analysis module 860 retrieves patient data and biomarker data from at least one database. The patient data may indicate if the patient has or is suspected of having a specific indication (i.e., disease). In some implementations, the patient data is extracted from the patient database 840 and converted into a form capable of being interpreted by the analysis module 860. For example, a patient may be represented as a variable or structure P having specific characteristics. The characteristics of P may a disease (or indication) I, one or more variants V₀, and the variants may have a reliability and relative abundance in the patient's cells. Accordingly, the patient may be represented as:

P=(I₀,V₀,reliability(V₀),percentage(V₀)).

Although referred to as variants V₀, in many implementations, characteristics of other biomarkers may be utilized. Furthermore, in many implementations, the absence of a biomarker may be characterized and utilized for analysis. For example, the absence of a particular protein in a patient that typically is found in other patients with the same indication may be significant, may indicate an underlying genetic or physiological difference in the patient, and may be correlated with differences in treatment outcomes that may be specific to the patient or other patients having the mutation or variation.

Similarly, the analysis module 860 may retrieve data from the mined databases 820. For example, the analysis module 860 may retrieve data characteristics of each of the biomarkers associated with an indication and/or patient. In some implementations, the data characterization of each biomarker may include at least one of: drugs used in treatment or other treatment methods (D), type of effect (T) (e.g., response, resistance, risk), expected response based on the knowledge of biomarker (S), evidence level (L), such that the analysis module 860 may characterize the biomarker as:

Bᵢ=(Iᵢ,Vᵢ,Dᵢ,Tᵢ,Sᵢ,Lᵢ).

In some implementations, T is equal to 1 when associated with a response and −1 when associated with a resistance. In further implementations, T may be set between 0 and −1 when associated with a risk (e.g. −0.2, −0.4, −0.6, or −0.8, or any other such value). This may allow for characterization of the severity of the risk (e.g. −0.2 for an annoying, but non-life threatening risk, and −0.8 for a potentially severe risk). In other implementations, T may be set to a greater negative value to indicate a risk, such that the system may distinguish between risk and resistance. For example, T may be set to −1 for a resistance, and may be set to a value greater than −1, such as −2, −3, −5, or any other such value to represent a risk of varying severity. In still other implementations, T may be set to a value between 0 and −1 for a risk of a minor side effect and to a value less than −1, such as −3 or −5, for a risk of a severe side effect. This may be useful in instances where a disease is life-threatening, and a minor side effect may be acceptable if there is sufficient benefit or response from the treatment.

At step 1002, the analysis module identifies a plurality of treatments associated with the indication and/or biomarker retrieved in step 1001. The associated treatments may be stored in a treatment information database 825. In some implementations, the treatment information database 825 is one of the mined databases 820, such that the treatments have been mined, gathered and organized by the data mining module 810 from the document sources 880. For example, in some implementations, a treatment may be considered associated with an indication and/or biomarker if it is found together with said indication and/or biomarker in literature. Various thresholds may be applied, including distribution or distance between references to the indication or biomarker and treatment, number or percentage of references to the indication or biomarker and treatment within an item of literature, frequency of appearance of the combination, number of citations to papers that include the combination, or other such thresholds or rules based off such information.

At step 1003, the analysis module 860 scores each of the retrieved treatment options. Generally, in some implementations, the score is based on at least one of: a clinical validation level of the biomarker; the biomarker's association with a response to the treatment, resistance to the treatment, or the risk of adverse effects from the treatment; and the reliability of the detection of the biomarker.

In some implementations, the above scoring process determines the applicability of at least one biomarker to the patient. In some implementations, the applicability of a biomarker is determined by the patient specific data and drug treatments available to the patient. For example, the applicability A of a biomarker Bᵢ to a fixed treatment Dₖ for a patient P may be represented as:

A(P,Dₖ,Bᵢ).

In some implementations, the calculation of the applicability A may involve the evidence level Lᵢ, the similarity(I₀, Iᵢ) between the patient's indication I₀ and the indication Iᵢ in which the biomarker is associated in the genomic database 821, the availability(I₀, Dᵢ) of a drug or treatment Dᵢ for the indication I₀, the reliability(Bᵢ) of the biomarker, the reliability of the variant V₀, the percentage of patient cells with variant V₀, the similarity between the patient variant V₀ and the variant Vᵢ associated with the biomarker Bᵢ or whether such variants are identical, and the similarity between the drug or treatment Dₖ and the drug or treatment Dᵢ associated with the biomarker Bᵢ or whether such drugs or treatments are identical. Accordingly, in some implementations, the applicability of a biomarker is represented as:

A(P,Dₖ,Bᵢ)=validity(Lᵢ)*reliability(Bᵢ);

or as

A(P,Dₖ,Bᵢ)=validity(Lᵢ)*similarity(I₀,Iᵢ)*reliability(Bᵢ);

or as

A(P,Dₖ,Bᵢ)=validity(Lᵢ)*similarity(I₀,Iᵢ)*availability(I₀,Dᵢ)*reliability(Bᵢ);

or as

A(P,Dₖ,Bᵢ)=validity(Lᵢ)*availability(I₀,Dᵢ)*reliability(Bᵢ);

or as

A(P,Dₖ,Bᵢ)=validity(Lᵢ)*similarity(I₀,Iᵢ)*availability(I₀,Dᵢ)*reliability(V₀)*percentage(V₀);

or as

A(P,Dₖ,Bᵢ)=validity(Lᵢ)*similarity(I₀Iᵢ)*availability(I₀,Dᵢ)*reliability(V₀)*percentage(V₀)*identical(V₀,Vᵢ);

or as

A(P,Dₖ,Bᵢ)=validity(Lᵢ)*similarity(I₀,Iᵢ)*availability(I₀,Dᵢ)*reliability(V₀)*percentage(V₀)*identical(Dₖ,Dᵢ);

or as

A(P,Dₖ,Bᵢ)=validity(Lᵢ)*similarity(I₀,Iᵢ)*availability(I₀,Dᵢ)*reliability(V₀)*percentage(V₀)*identical(V₀,Vᵢ)*identical(Dₖ,Dᵢ).

In some implementations, the above-described variables are normalized between 0 and 1 to indicate their effect on biomarker applicability. For instance, the evidence level L may be mapped from 1 to 0, such that when the variant is “KOL endorsed” validity(Lᵢ)=1, and if the variant is “inferred” validity(Lᵢ)=0.2. This may imply that an inferred biomarker is considered only 20% of the amount of evidence of an endorsed one, possibly to reflect that there is only about 20% chance that the biomarker would ever be fully confirmed and endorsed. In a further implementation, the relevance of an inferred biomarker or validity(Lᵢ) may be set to a predetermined value responsive to whether standard treatment guidelines are available for the patient. For example, as discussed above, if such standard treatment guidelines are available, then the relevance of an inferred biomarker validity(Lᵢ) may be set equal to 0 or a similarly small value, such as 0.01. In other implementations, the standard treatment may be prioritized over other treatments as a default rule, regardless of prioritization of other treatments. If guidelines are not available and/or no other biomarkers are found, then the relevance of the inferred biomarker validity(Lᵢ) may be increased to a predetermined level, such as 0.2, 0.3, 0.5, or any other such value. In some implementations, validity(Lᵢ) is set to 1 when “KOL endorsed”; between 1 and 0.5 when clinically validated, and less than or equal to 0.2 when pre-clinically validated. Similarly, for similarity(I₀, Iᵢ) a value of 1 may be used to encode that two entities are identical and/or that the biomarker has been validated in an indication of the patient; values between 0 and 1 could correspond to the likelihood of the analogous biomarker to be valid for a related indication I₀ instead of Iᵢ, and a value of 0 would indicate that no transfer should be made between the unrelated indications (in the context of the given variant, etc). The similarity of I₀, Iᵢ and/or V₀, Vᵢ may be include molecular level similarities such as homology or expression of key proteins and/or the structure of the exchanged amino acids. Similarity values may not be a dichotomy; rather, values between 0 and 1 may be used, such as 0.2, 0.4, 0.6, 0.8, or any other such value for a related indication, and values of 0, 0.01, 0.02, 0.05, 0.1, or any other such value for an unrelated indication. Different values may be used responsive to other shared characteristics between the indications, such as whether they involve the same pathway, same organ, or other such characteristics. Likewise, similar or identical drugs or treatments Dₖ, Dᵢ may be encoded with values of 1 to indicate identical treatments, or values between 0 and 1 to indicate similar but non-identical treatments (e.g. conventional external beam radiation therapy, stereotactic radiosurgery, intensity-modulated radiation therapy, etc.). In some implementations, reliability(Bᵢ) is the average of a value for the reliability of the detection method of the biomarker and a value for the frequency for the detection of the biomarker in the patient. In other implementations, some, or all, of the above of the above characteristics may be combined in different ways. For example, some terms may be correlated and those terms may be averaged, e.g. geometrically or arithmetically, before determining the applicability A. In yet other implementations, the above characteristics may be summed to return an applicability A.

In many implementations, applicability A may be determined for each of a plurality of biomarkers associated with the patient, including biomarkers detected in the patient or expected biomarkers that are not detected in the patient. These thereby determined multiple applicability scores—may be aggregated over all applicable biomarkers to generate a score for a specific treatment for the patient, based on their specific physiology and/or genotype. In some implementations, the effects are grouped by the above-described type T (e.g., response, resistance, risk) for each drug or treatment, each group being provided with a separate score. In other implementations, the groupings may be summed with a weighting factor, wherein the weighting factor may be the effect size S. The product of the applicability A with the effect size Sᵢ may be referred to as a sub-score. The effect size may comprise a measurement of a likelihood of response or resistance of a treatment in patients having the indication and biomarker, or a measurement of a hazard ratio of adverse events experienced by patients having the indication and biomarker undergoing the treatment. Such measurements may be actual data values, percentages, proportional reporting ratios, log ratios, or other values or types of values. Multiplying by the effect size may be interpreted as the estimated probability of the effect of biomarker Bᵢ to be seen in the given patient when treated with drug or treatment Dₖ. Accordingly, the summed effect may be represented as:

$${S}_{p} ( P , {D}_{k} , {T}_{1} ) = {\sum }_{Ti = T 1} A ( P , {D}_{k} , {B}_{i} ) {S}_{i}$$

In some implementations, if no biomarkers are applicable, drugs may still be prioritized based on their expected effects. This effect may be classified as the base effect S₀ of the drug or treatment on a patient with no variants. Therefore, the total effect for a patient may be:

S_{T}=S₀+S_{P}

In some implementations, a single treatment score t is determined for each treatment based on the effect of the drug or treatment over each of the above-described types. For example:

t(P,Dₖ)=ƒ[S(P,Dₖ,Response),S(P,Dₖ,Resistance),S(P,Dₖ,Risk)]

The function ƒ may be a function that maps the three effects to a single treatment score t. In some implementations, the weights given to each of the S terms depends on the severity of the indication and/or individual preferences regarding the trade-off between risk and benefit for taking a specific drug. In some implementations, S_{RESPONSE} and S_{RESISTANCE} are inversely correlated, such that if a patient is more responsive, the patient must be, by definition, less resistant to the drug. Therefore, in some implementations, S_{RESPONSE} and S_{RESISTANCE} are combined into a single S term. In some implementations, the treatments are then ranked based on the treatment score t.

At step 1004, a least a portion of the identified treatments are prioritized response to the determined scores. In some implementations, treatments with lower scores may be ordered lower than treatments with higher scores. The treatments may also be organized by their above described effect type T. For example, the treatments that the analysis module 860 determines the patient should respond to may be grouped separate from the treatments to which the patient may be resistant.

While the invention is particularly shown and described with reference to specific embodiments, it should be understood by those skilled in the art that various changes in form and detail may be made therein without departing from the spirit and scope of the invention described in this disclosure.

1-45. (canceled)

46. A method for prioritizing treatment decisions, comprising:
retrieving, by an analyzer executed by a processor of a computing device, an identification of a patient indication;
identifying, by the analyzer, a plurality of proteins or genes associated with the patient indication, and at least one genetic variant associated with the patient indication;
selecting, by the analyzer, a subset of the plurality of proteins or genes responsive to an identified functional impact of the genetic variant on the protein or gene associated with the patient identification;
generating, by the analyzer, an indication-specific molecular entity network based on the selected subset of the plurality of proteins or genes;
retrieving, by the analyzer from a medication information database, an identification of a plurality of medications having one or more targets in the indication-specific molecular entity network; and
generating, by the analyzer, a prioritized list of suggested treatments, each comprising one or more of the plurality of medications, wherein the priority of a suggested treatment depends on a number of targets in the indication-specific molecular entity network affected by the one or more medications of the suggested treatment.

47. The method of claim 46, wherein identifying a plurality of proteins or genes associated with the patient indication comprises searching a literature database for identifications of a protein or gene having a co-occurrence frequency with identifications of the patient indication greater than a first threshold.

48. The method of claim 46, wherein identifying at least one genetic variant associated with the patient indication comprises searching a literature database for identifications of a genetic variant having a co-occurrence frequency with identifications of the patient indication greater than a second threshold.

49. The method of claim 46, wherein selecting a subset of the plurality of proteins or genes further comprises identifying activation or repression of a gene or amplification or deletion of a protein by the genetic variant, and selecting said protein or gene for inclusion in the indication-specific molecular entity network responsive to the identification.

50. The method of claim 49, wherein identifying activation or repression of a gene or amplification or deletion of a protein by the genetic variant comprises searching a literature database for identifications of the protein or gene having a co-occurrence frequency with identifications of the genetic variant and identifications of activation, repression, amplification, or deletion.

51. The method of claim 46, wherein generating an indication-specific molecular entity network comprises extracting a subgraph from a global molecular entity graph, the subgraph comprising the selected subset of the plurality of proteins or genes.

52. The method of claim 46, wherein the priority of a suggested treatment is further based on a stage of development of a medication of the suggested treatment.

53. The method of claim 46, wherein the priority of a suggested treatment is proportional to the number of targets in the indication-specific molecular entity network affected by the one or more medications of the suggested treatment.

54. The method of claim 46, wherein the priority of a suggested treatment is dependent on a number of medications of the suggested treatment.

55. The method of claim 54, wherein the priority of a suggested treatment is inversely proportional to the number of medications of the suggested treatment.

56. A system for prioritizing treatment decisions, comprising:
a computing device comprising a processor and a memory, the processor executing an analyzer configured for:
retrieving an identification of a patient indication;
identifying a plurality of proteins or genes associated with the patient indication, and at least one genetic variant associated with the patient indication;
selecting a subset of the plurality of proteins or genes responsive to an identified functional impact of the genetic variant on the protein or gene associated with the patient identification;
generating an indication-specific molecular entity network based on the selected subset of the plurality of proteins or genes;
retrieving, from a medication information database, an identification of a plurality of medications having one or more targets in the indication-specific molecular entity network; and
generating a prioritized list of suggested treatments, each comprising one or more of the plurality of medications, wherein the priority of a suggested treatment is dependent on a number of targets in the indication-specific molecular entity network affected by the one or more medications of the suggested treatment.

57. The system of claim 56, wherein the analyzer is further configured for searching a literature database for identifications of a protein or gene having a co-occurrence frequency with identifications of the patient indication greater than a first threshold.

58. The system of claim 56, wherein the analyzer is further configured for searching a literature database for identifications of a genetic variant having a co-occurrence frequency with identifications of the patient indication greater than a second threshold.

59. The system of claim 56, wherein the analyzer is further configured for identifying activation or repression of a gene or amplification or deletion of a protein by the genetic variant, and selecting said protein or gene for inclusion in the indication-specific molecular entity network responsive to the identification.

60. The system of claim 59, wherein the analyzer is further configured for searching a literature database for identifications of the protein or gene having a co-occurrence frequency with identifications of the genetic variant and identifications of activation, repression, amplification, or deletion.

61. The system of claim 56, wherein the analyzer is further configured for extracting a subgraph from a global molecular entity graph, the subgraph comprising the selected subset of the plurality of proteins or genes.

62. The system of claim 56, wherein the priority of a suggested treatment is further based on a stage of development of a medication of the suggested treatment.

63. The system of claim 56, wherein the priority of a suggested treatment is dependent on the number of medications of the suggested treatment.

64-90. (canceled)

91. The system of claim 63, wherein the priority of a suggested treatment is inversely proportional to the number of medications of the suggested treatment.

92. The system of claim 56, wherein the priority of a suggested treatment is proportional to the number of targets in the indication-specific molecular entity network affected by the one or more medications of the suggested treatment.
